(19) United States
(12) Patent Application Publication
(10) Pub. No.: US 2017/0024767 A1
(43) Pub. Date: Jan. 26, 2017

(54) Technology System to Develop and Support Community News Services with Multi-Dimensional Marketing and Distributed Computing.

(71) Applicants: William V Johnson, JR., Lanesville, IN (US); Michael E Johnson, New Albany, IN (US)

(72) Inventors: William V Johnson, JR., Lanesville, IN (US); Michael E Johnson, New Albany, IN (US)

(21) Appl. No.: 15/287,730

(22) Filed: Oct. 6, 2016

Related U.S. Application Data
(63) Continuation-in-part of application No. 13/507,598, filed on Jul. 12, 2012.

(51) Int. Cl. G06Q 30/02

(52) U.S. Cl. CPC G06Q 30/0261; G06Q 30/0277; G06Q 30/0201

(57) ABSTRACT

A system to create independent, local, online news services is described. User created content is aggregated to create local news services based on geographical segments and independent content contributors. Content is gathered from independent members and then segmented into web pages. Web pages utilize databases to segment the news content based on population by physical location. The content is then further segmented into categories and areas of interest. Individuals, who want to contribute content, are required to become members of a multi-level marketing network. The multi-level marketing network of members monitors an individual member's content that they provide to the news service. A rating system enables members and consumers to evaluate the content. Members are compensated on revenue that they and the members in their multi-level marketing group produce by marketing advertising and business services. The News Event and News Alert System Architecture depicts the major components of the news event and alerting system. The NDS is the primary network service used by MANA. News events are collected and analyzed. Location and category features are compared to each MANA location and category preferences and alerts are generated.

### CROSS REFERENCED TO RELATED APPLICATIONS

Not Applicable

### FEDERALLY SPONSORED RESEARCH

Not Applicable

### SEQUENCE LISTING OR PROGRAM

Not Applicable

### BACKGROUND

Field

The application relates to a technology system to enable the distributed coordination of large numbers of reporters, editors, and managers using a Multi-Level Marketing (MLM) structure to support what may be called crowd sourced news. In addition, this application also uses devices communicating with a Multiple Access News Application (MANA) and a News Event Data Structure (NEDS) to enable faster and more efficient distribution of vetted news with location specificity.

Prior Art

News services today are primarily delivered by traditional news sources, such as newspaper, television, and radio. These media sources have limited resources for producing news content. Content is created by journalists or reporters that are employed by the media sources. The ability to increase news content is restricted by the number of journalists and reporters that these traditional news services employ. Their ability to employ more journalist and reporters is limited by the revenue that the media sources can produce.

The traditional media sources are targeted to medium and large metropolitan cities that can produce enough revenue to sustain the media business. Since these media sources have limited funding and employees, their geographic reach of news coverage is also limited based on these constraints. The traditional media sources produce content and cover news that is of general interest to all citizens, or of specific interest only to citizens of the metropolitan cities where they are located. Since there are a limited number of newspapers, television stations and radio stations, many communities have no coverage of local news that is specific to their communities.

The current management structure for today's media sources are traditional linear management structures. Journalists and reporters must operate within a business structure that limits independence. Media organizations can be biased in their coverage of the news. With a linear management structure the choice of stories that will be covered and the amount of resources to use in covering the stories are decided by upper management of these news organizations. Many times journalists and reporters are not free to choose what news they want to cover. Stories that are covered may have the content and presentation of the news influenced by the management of the organization.

The linear management structure in the media business also creates a problem with hiring and training more journalists and reporters. Since these journalist and reporters are employees of the media company, they are limited in how big the organization can be based on the time that management has to hire and train new reporters. Each journalist and reporter has a boss, who has another boss, who has another boss. This business structure limits growth of the media source.

The ability of media sources to produce revenues is primarily driven by advertising revenue. With the traditional sources of newspapers, television and radio, there is a limited amount of advertising space to sell. Newspapers are limited in the number of pages in the newspaper and the open space on each page to insert advertisers. Television and radio are limited by 24 hours in each day to either provide content or provide advertising on their stations.

Traditional media sources have a limited appeal to advertisers that operate businesses outside of the media sources geographic news coverage. Media companies primarily cover news in medium to large cities or stories of national or international interests. Businesses that operate in communities that do not have a direct media source have little interest in advertising in those media outlets. Communities that do not have media coverage have limited opportunities for their local businesses to advertise.

Traditional media sources have limited appeal to citizens outside of the media sources geographic news coverage. Citizens in most small cities and towns do not have a media company covering their local news. News in small cities and towns is still primarily disseminated by word of mouth.

The internet has created a medium that can reach all citizens of every community for very little cost. This has prompted many news services to move their content to an online format. The internet has also prompted the creation of news businesses that aggregate news in many new methods to appeal to specific readers. However, the majority of news on the internet is still produced by traditional media companies. This news is still subject to most limitations listed above. The internet is full of websites that take news and aggregate it in unique formats. News from city to city or country to country can be linked and organized in many combinations. While the new combination of news and ease of use creates new interest among readers, there is no new original content produced outside of what the traditional media sources are providing.

Other websites ask readers to comment on the news by utilizing chat rooms, message boards and opinion polls to increase readership. This creates new original content in the form of readers' comments and opinions. While these sites create an interesting forum for readers to communicate with each other, there is still no new news content produced.

In an effort to create independent news sources, there are a few online news sites that have attempted to develop content from sources outside of the traditional media outlets. These sites have been unsuccessful in producing any significant level of content from independent sources. The problem with the current independent news internet sites is that there is no monetary incentive for individuals to provide content to the site. The content that is provided to the few sites that are attempting to provide independent news is dominated by individuals providing opinions on the news. There is no direct reporting of local news being provided on these sites.

Below are two examples of websites that promote citizen journalists and list the websites on the internet that are attempting to create independent news. These sites are Center for Citizens Media, www.citmedia.org, and Knight Citizen News Network, www.kcnn.org. These current sites are dominated by reorganizing already published news items to interest readers of a specific geography, and by independent contributors giving their opinion of the published news items. Original, local, independent news content is not being created and independent content providers are not being compensated for their content. Community news is still not being disseminated in any significant volume.

As stated above, the existing services that offer citizen contributors' content do not provide a compensation structure to provide a source of income for the independent contributors. Currently, citizen content contributors are encouraged to submit independent content for free. This lack of compensation has hindered any proliferation of independent, community based news.

Social media is another online outlet for citizens to provide content. This would include sites such as Facebook and Twitter. Similar to the sites discussed above, these social media sites do not provide compensation to content contributors. Content is created to share news and opinions among citizens that already have an established relationship with no financial incentives available to the content contributor. Another limitation is that the content is not available to the general public. You must be a member of the social media site and have a relationship with the content contributor to see their content.

These sites also do not segment content by geography or areas of interest. Content is segmented and categorized by these established relationships and classifications. The content is not segmented based on geography and areas of interest. This dispersion prohibits most local businesses from being able to target advertisements to a specific location or interest. With no geographic segmentation, no compensation for contributors, no availability of content to the general public, and limitations based on established relationships, social media sites do not provide a viable platform to develop independent, local news services.

Most small and medium size communities do not have an online news service that is dedicated to news and interests based on their local needs. Medium and large size communities that do have online news services for their communities are limited in scope of coverage, limited in resources, limited in independence and limited in staff. The current structure of online news services is for the service provider to choose what news and community interests are important. This application offers a new method and process of creating online news services that will enable the community citizens to decide what news and community interests are important.

### PATENTS AND PATENT APPLICATIONS REVIEWED

Gerace (US-2007/0118802 A1):

Gerace appears to lay claim to general content management systems (CMS). It could be applied to traditional news by enabling authors to contribute articles, segment and categorize their articles, and be compensated for creating news articles. Gerace discusses many ways for the author to create and distribute their articles and many ways for the author to be compensated. However, the means of an author being compensated in Gerace are still centered around revenues of the general news service and limitations in budgets set by a traditional news service. Authors may also be compensated differently at the discretion of the news service. Gerace fails to provide an active incentive for local citizens in a community to report on news in their community like a MLM group would. The structure is no different than independent news services, already in existence, that are trying to pay for content from a general fund from the news service. Gerace also fails to provide a process bringing local businesses to advertise on their news service, because there is no pre-determined segmentation of geographic news specific to the advertiser's locality. In addition, there is no processing function to include these same content providers into the compensation calculation as does the CNS sales force for the advertising within the geographic areas.

The current invention solves the limitations present in Gerace, and those that are also present in other traditional news media today. Central to the invention is the idea of a multi-dimensional marketing network with each geography (such as a zip code) having revenue pools and article credit pools specific to their geographic area. Advertisers are able to target advertising to their local area and the revenues are used locally to compensate authors in that local area, authors are compensated for writing articles about that local area, and readers can access a news service that is specific to their local area. This multi-dimensional marketing compensation structure described in the current application enables a local news reporting service to be present in an unlimited number of localities and support an unlimited numbers of news contributors. This invention can transform how community news is reported across the country, by giving local citizens the opportunity to become members, report news, sell advertising, and recruit others to the same.

Wright (US-2009/0265245 A1):

Wright discusses interactive communications between advertisers and consumers and different methods for achieving this 2 way communication. Wright does not appear to address geographic segmentation. In paragraphs 88 and 139, Wright does mention the words Multi-Level Marketing (MLM), but they are not talking about actual multi-level marketing networks. They misuse the phrase to describe their communications systems ability to allow advertisers multiple ways to market their information to consumers. They are not talking about the well-known compensation structure of what is commonly referred to as a MLM networks. Therefore, it is believed that Wright qualifies as non-analogous art.

Gerace cannot be combined with Wright without some missing processing steps to allocate value and revenue between Wrights users and Gerace's CMS. Gerace provides no way to calculate the allocation of revenue due each user of Wright's MLM. Wright provides no way to calculate the value of content created by its members on Gerace's CMS. Therefore, one skilled in the art would expect a simple combination Gerace and Wright combined to fail to provide a viable news service because there is no obvious way to combine them.

The current invention is not merely a combination of old elements that perform the same functions as they did separately. Rather, it is a system that enables a special combination of known functions which depend on additional new functions and is further specialized to support a community news service. The share of revenue attributable to a member is calculated in process steps involving geographic pools, article credits within each pool, associated ratings, MLM bonus, and sales commissions. The value of content created by a member is calculated as article credits within each pool.

Farr (U.S. Pat. No. 8,271,526 B2):

Farr discusses a user of a content service having the ability to delete or edit the content of another user, depending on the first user's access level. While ratings from users may be one reason to modify content of another user, Farr does not appear to mention the use of ratings in a compensation structure. There is no discussion of geographic segmentation of revenue pools or article credit pools within a multi-dimensional marketing.

Our invention solves the limitations in Farr. The invention may utilize ratings to allow for modification to a user's content as well. However, our invention also may utilize ratings to incent the right behavior by linking the ratings to the compensation of the user. Thereby monetarily rewarding users that provide good content and penalizing those users that do not.

Bamborough (U.S. Pat. No. 7,778,884 B2):

Bamborough discusses using a multi-level marketing compensation structure for e-commerce. They discuss members' ability to market products and recruit others to do the same. They also discuss the members being able to buy products as wholesale in a “membership buying club.” Bamborough does not appear to mention content creation or product creation. As with most MLM companies the members buy and sell products that the company produces. Their members do not create products. Bamborough also does not enable segmenting the members and revenue dollars into geographic areas in order for each geographic area and the members within that area to directly benefit their location. There is no teaching of geographic segmentation of revenue pools or article credit pools within a multi-dimensional marketing network.

Arganbright (U.S. Pat. No. 6,980,962 B1):

Arganbright does discuss multi-level marketing networks and the use of the internet for conducting business. Arganbright describes a system and method for a single marketing distribution system that can distribute products of several different sellers. They do not mention content creation or geographic segmentation of revenues. There is no discussion of geographic segmentation of revenue pools or article credit pools within a multi-dimensional marketing network to promote and incentivize news reporting in a specific geographic location.

Au (US-2009/0037235 A1):

Au describes a rating system to select candidates for hiring. Au does not discuss a rating system in relation to a compensation plan. There is no discussion of geographic segmentation of revenue pools or article credit pools within a multi-dimensional marketing network to promote and incentivize news reporting in a specific geographic location.

Shell (U.S. Pat. No. 6,691,093):

Shell describes a multi-level marketing structure within in an electronic payment system. They focus on how members get paid in an electronic environment and how products can be cataloged. There is no discussion of geographic segmentation of revenue pools or article credit pools within a multi-dimensional marketing network to promote and incentivize news reporting in a specific geographic location.

Fisher (U.S. Pat. No. 8,234,175 B2):

Fisher describes a system for distribution of digital merchandise. The focus of the patent is to enable sharing, avoid piracy and ensure payment for the appropriate parties involved. There is no discussion of geographic segmentation of revenue pools or article credit pools within a multi-dimensional marketing network to promote and incentivize news reporting in a specific geographic location.

Fisher et al. teaches a method to buy, sell, and transfer Digital Merchandise Items (DMIs). It also teaches that ratings may be used to adjust the compensation of DMI creators. The main difference from the primary application calculation, but that is only one aspect of a community news service. Fisher et al. does not teach a geographic based revenue pool or member contributions and allotment from such geographic pools. It also does not teach the use of article credits whereby members compensation is partially based on the contribution of news content to the service and allocated on a geographic and usage level.

Nicholas (US-2006/0026067):

Nicholas describes targeted advertising on the internet. They do mention using geography as one element to determine where to place ads, however it is specific to the placement of ads and they do not mention utilizing geographic location in a compensation structure. There is no discussion of geographic segmentation of revenue pools or article credit pools within a multi-dimensional marketing network to promote and incentivize news reporting in a specific geographic location.

Gagnon (U.S. Pat. No. 6,421,648 B1):

Gagnon describes variations of a multi-level marketing compensation system. Gagnon focus is on different profit margins on different products and different payouts for different efforts from members. Yet they still stay within the traditional definition of a multi-level marketing structure, sell pre-defined products and recruit others to do the same. There is no discussion of geographic segmentation of revenue pools or article credit pools within a multi-dimensional marketing network to promote and incentivize news reporting in a specific geographic location.

Urso (US-2012/0010926 A1):

Urso describes the logistics of a multi-level marketing compensation plan. While the flow of payment may differ from other multi-level marketing compensation plans, it still stays within the traditional multi-level marketing format of selling pre-defined products and recruiting others to do the same. There is no discussion of geographic segmentation of revenue pools or article credit pools within a multi-dimensional marketing network to promote and incentivize news reporting in a specific geographic location.

Urso describes a multilevel marketing structure. The novel part of the disclosure seems to center on the creation of associated teams assembled within a traditional multi-level marketing structure for product sales. It creates a team bonus that may be distributed to members of the team.

A primary difference from the present application is that Urso does not teach a geographic based revenue pool or member contributions and allotment from the geographic pools. The geographic dimension is fundamental to a news service and is a key component that allows a multi-level marketing (MLM) method to be applied to a news service as described in the current application. Further, the traditional MLM is based on product sales. It provides no way for news content creators to sell their news items as a product and thus be compensated. It also does not teach the use of article credits whereby members compensation is partially based on the contribution of news content to the service and allocated on a geographic and usage level. The article credits (AC) and geographic pools (GP) allow a way for creators of news content created within a GP to be compensated via the revenue generated in that GP.

Herz (U.S. Pat. No. 7,630,986):

Herz is a fundamentally different invention in that it claims to restrict and control data exchange with different rules for different buyers and sellers, restrict and control pricing for the exchange with different rules for different buyers and sellers, and limit the use of data at the will of the data provider. Our invention does not restrict data, does not provide pricing controls, does not enable different parties to set varying parameters for data access and pricing.

Herz does not seem to mention a news service except as an example where access to news could be limited using “Secure Data Interchange” rules as described.

Herz teaches a multi-level marketing network organization, but only as possible users of its claim 1 regarding automated seller and buyer software agents using common price rules as a “data access control mechanism.” Our invention limits multi-level marketing as a part of a local news service's management and compensation process, a fundamentally different process from data access control.

Herz col. 136 line (49) “A part of a consumer's decision . . . ” does not seem to reference multi-level marketing.

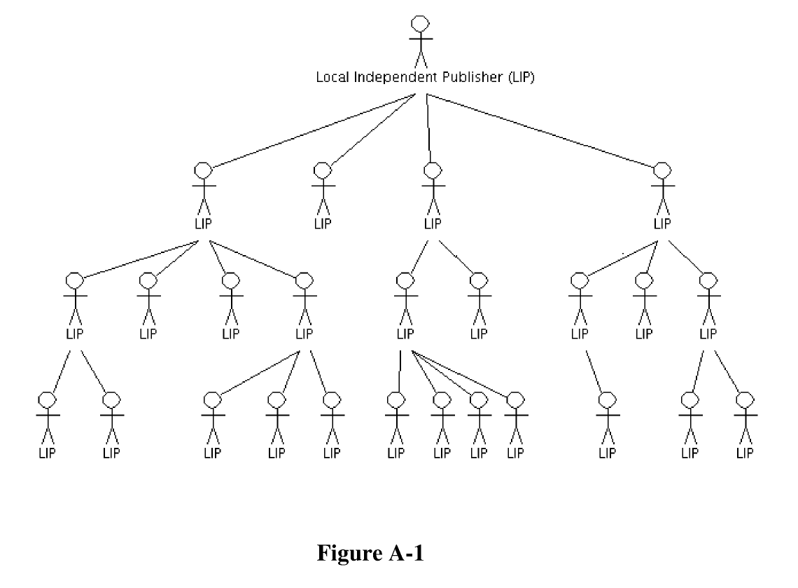

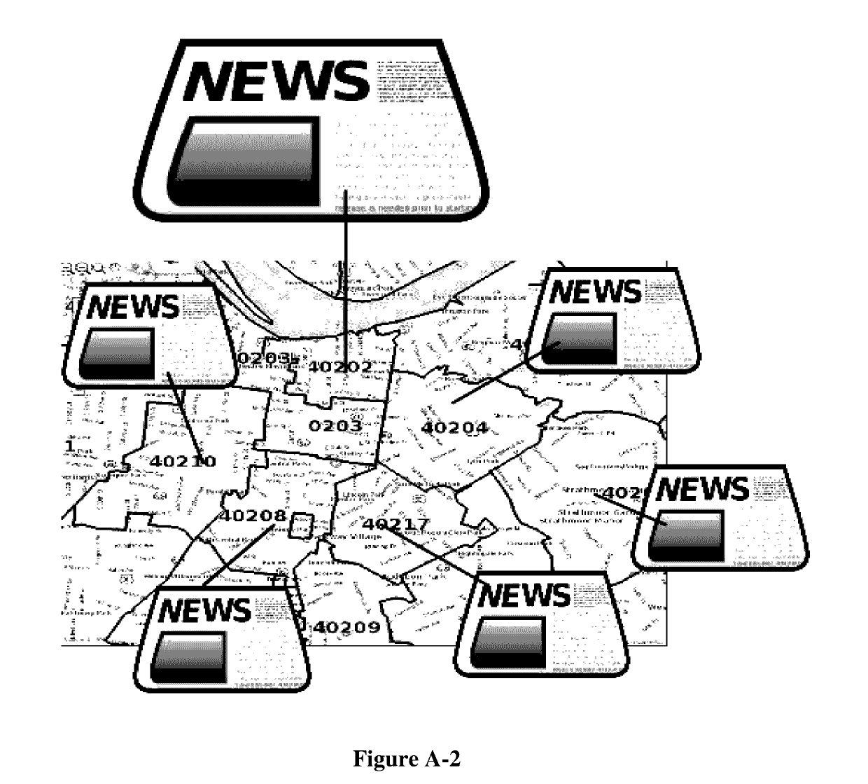

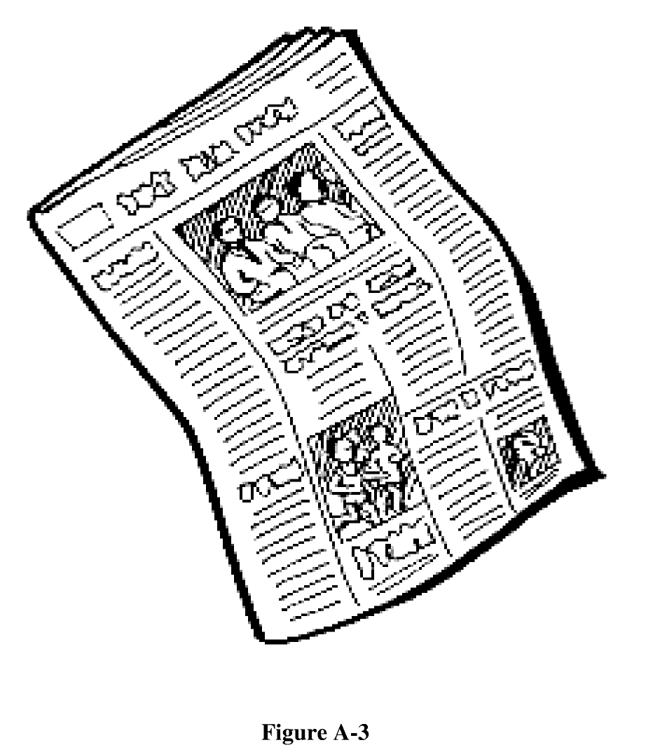

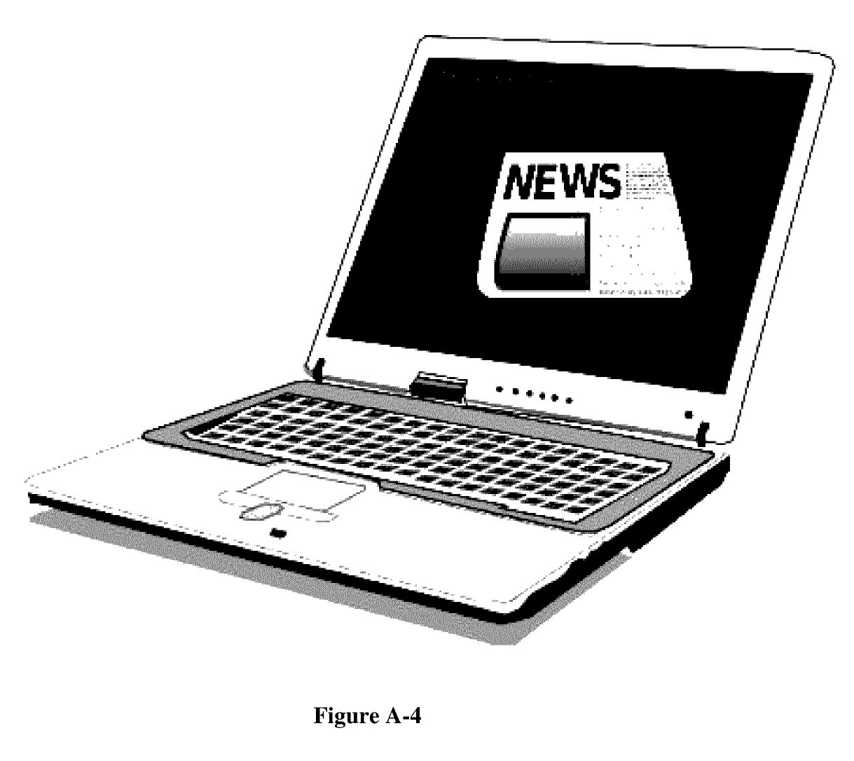

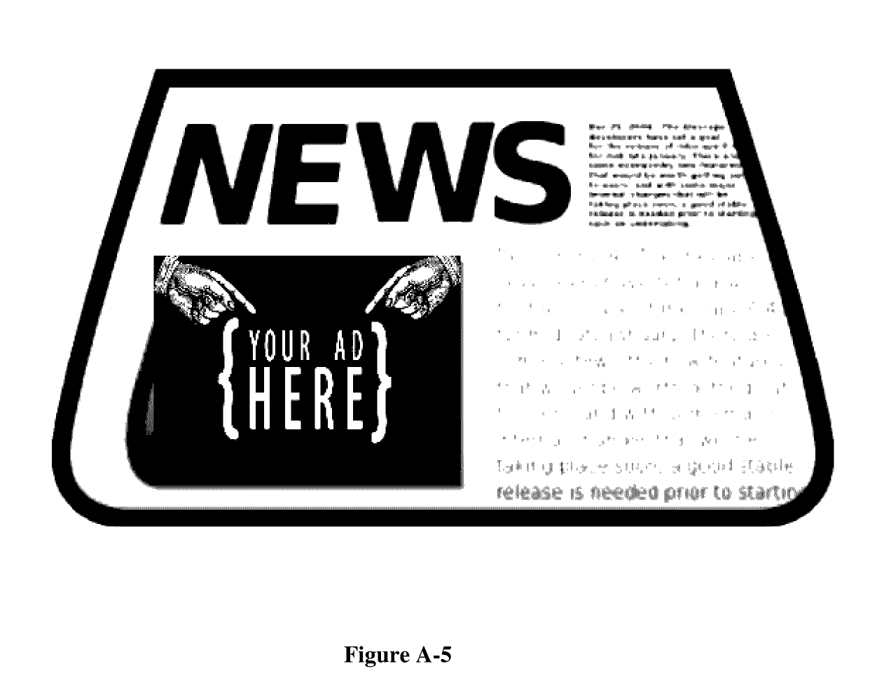

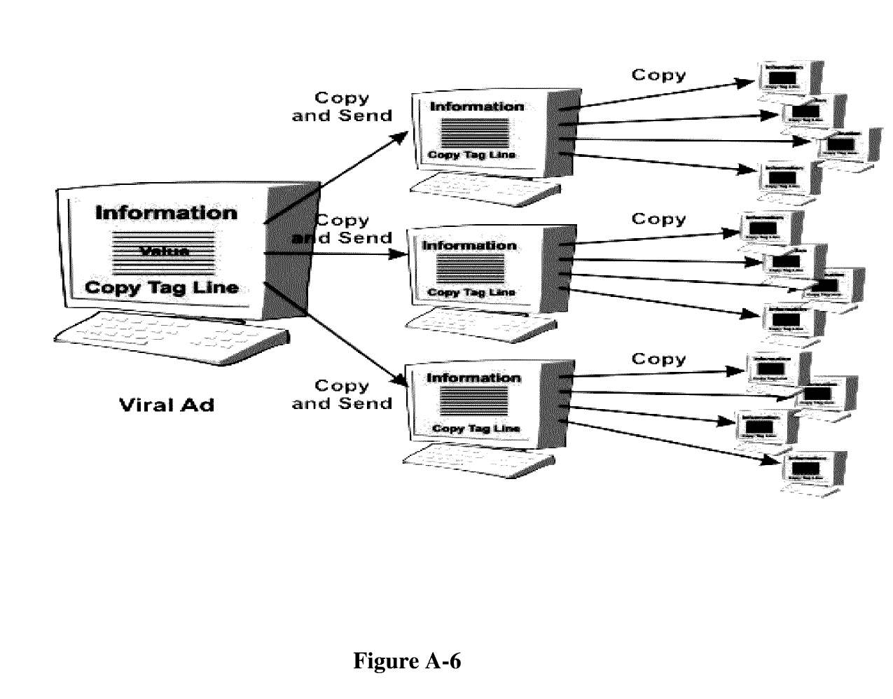

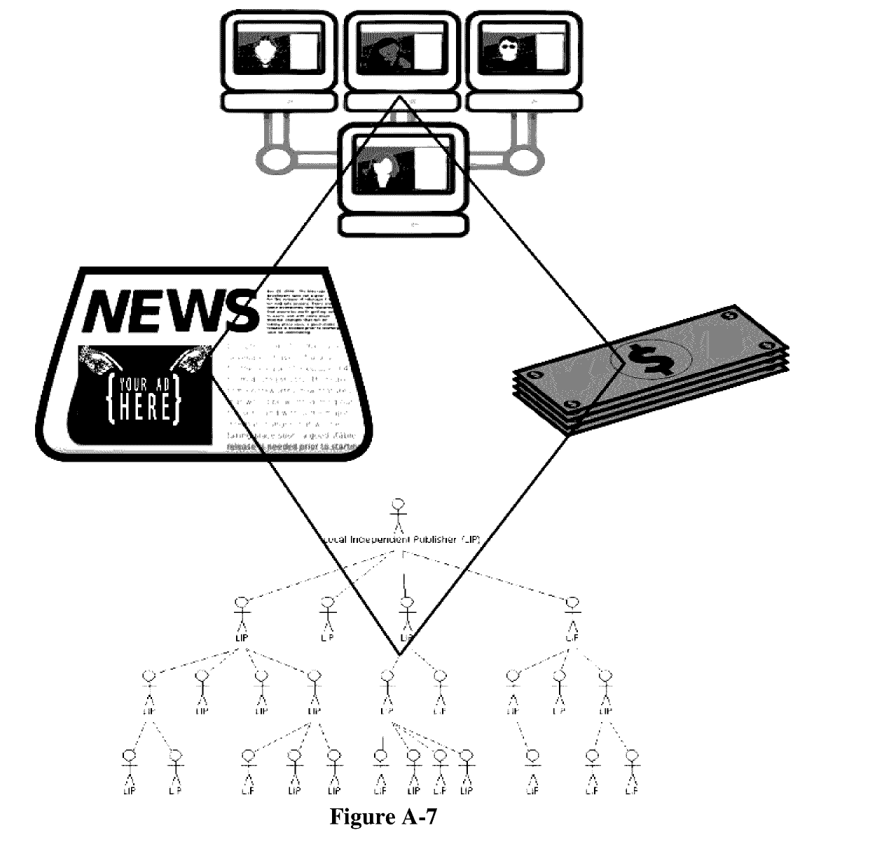

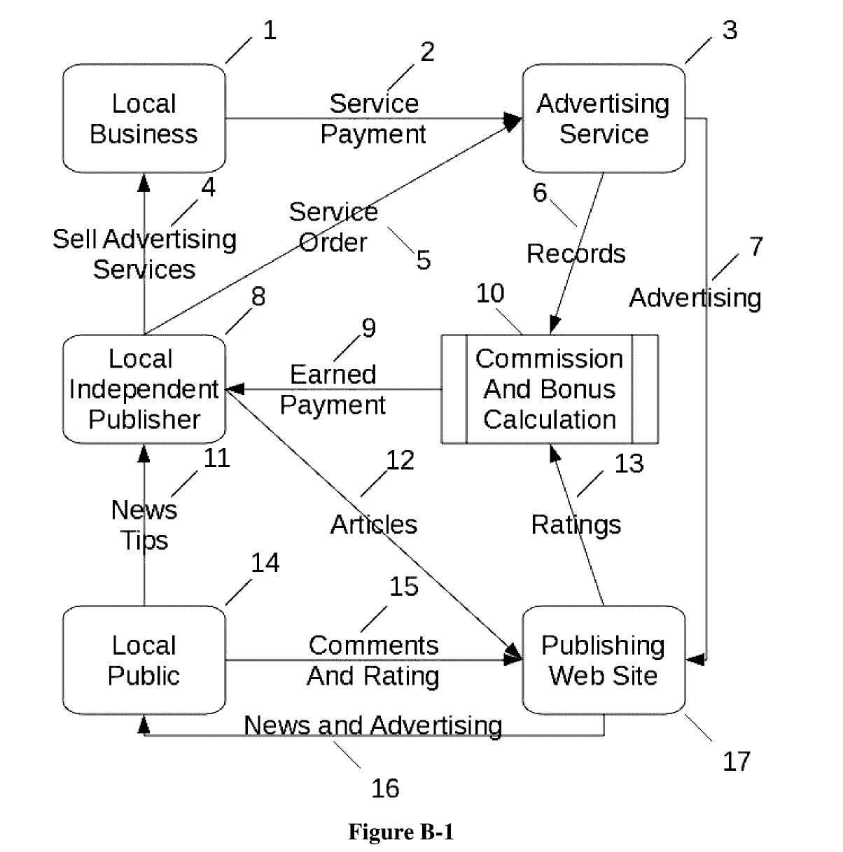

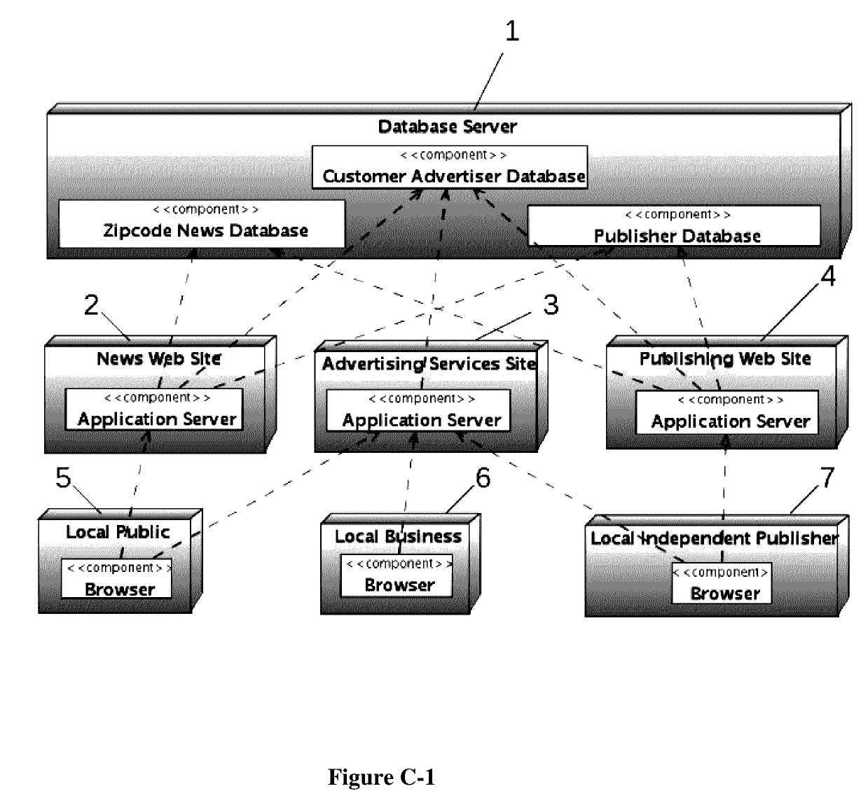

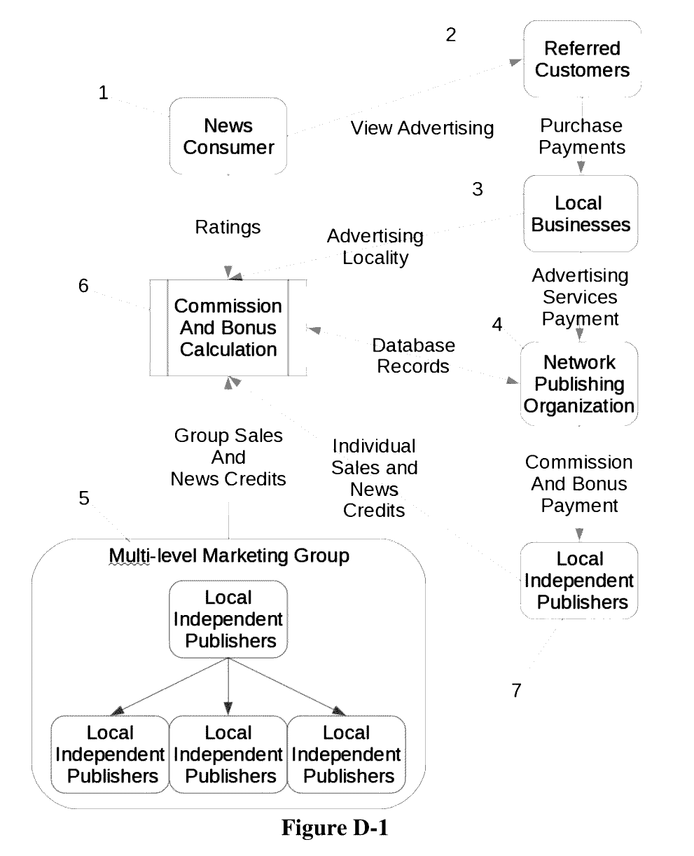

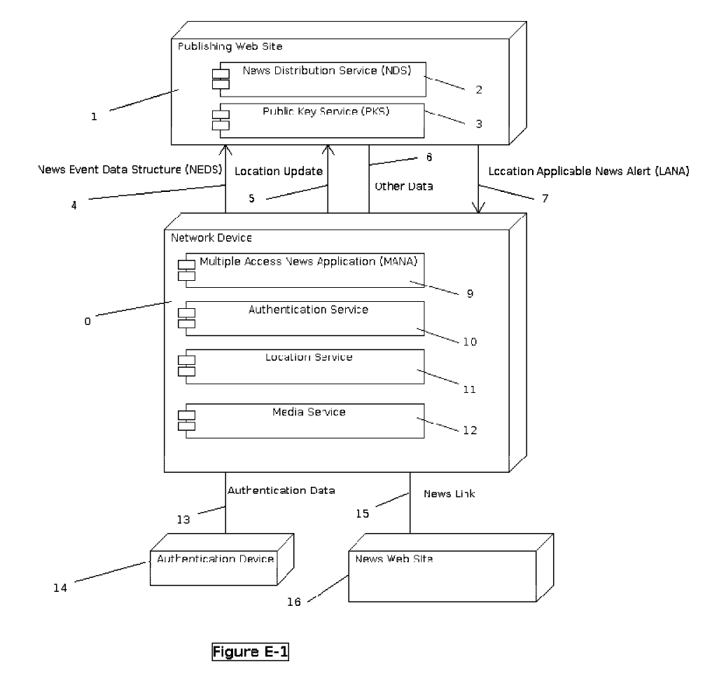

Herz col. 44 lines (35-63) “FIG. 8 provide . . . ” does not seem to reference geographic locations offering news services.

Herz geographic location is one possible tag under paragraph 13.1.1 Statistical Techniques for multi-dataset Collaborative Filtering. It is not part of a process step for marketing advertising. Our invention limits marketing to businesses in a geographic location as a part of a local news service, a fundamentally different process from a general geographic filter tag of data access control.

Ashida (US-2005/0080744):

Ashida is a fundamentally different invention whereby its claims are focused on multiple websites linked to a master website and revenue sharing among the web sites based on their respective contributions. Our invention uses a centralized database to maintain the content as opposed to a distributive network of websites. Our invention also claims geographical segmentation and the creation of independent local news content as required actions in the process.

Ashida does describe multi-level marketing in an application of the content management system but misses the geographic link to local news interest and the local advertisers that provides the revenue for distribution. It also describes multiple websites as members of the structure, while we describe a centralized website. Ashida teaches web sites on an internet but does not describe the recording of news by geographic location.

Au (US-2009/0037235):

Au is a fundamentally different invention whereby its claims are focused on the employment function of identifying candidates for employment.

Au par. 0089 does not seem to reference newspapers or multi-level marketing. Multi-level marketing is not considered a non-functional data label in our invention. It is described and claimed as a key element of the invention and is required for the functionality of our process.

Moukas (US-2009/0138361):

While Moukas does describe advertising in an electronic format, it is not specific to supporting a local news service and it is not specific to geographic segmentation enabling the advertisers to target their advertising.

Alhadeff (U.S. Pat. No. 8,499,241):

Alhadeff seems to describe referring content, but does not seem to address publishing original content. He also misses the process actions of using a multi-level marketing organization across multiple geographic locations and segmented by those localities.

### SUMMARY

For the first time in history, most anyone can publish and distribute most any information for near zero cost. This application combines the technology of the internet with the power of free enterprise of multi-level network marketing to create, organize, and distribute local information in a new way. Local citizen reporters are recruited to report personally interesting news items. The local content will draw local internet traffic. This locally focused traffic enables locally targeted advertising. The business model is new to the traditional media business model of creating, organizing and distributing news and the business model is new to the traditional advertising business model of marketing, creating, organizing, and distributing advertising. The number of reporters is not limited by operating budget resulting in an explosive growth in articles, subject matter, reporting speed, and viewpoint coverage. Instead of merely tracking circulation numbers, internet technology allows fine grained tracking of every facet of an articles interest level. Advertising then takes on several new dimensions in targeting, tracking, and efficiency. The management model is also different due to the number of small-time reporters being supported. The multi-level network marketing business model is used by successful consumer product companies to support large numbers of small business operators. Applying this business model to the news industry enables a large number of individuals to earn money in a small business of their own by reporting news and selling advertising and related services. The graduated bonus schedule of the multi-level network marketing business model provides monetary incentive for these small business owners to recruit and manage other individuals to start their own business selling news and advertising services. The resulting legion of citizen reporters and sales people will enable a gainful new level of local news, local interest, and local advertising.

We have invented a system that enables local news to be economically viable. It creates a central portal for access to local news for any locality in the United States, whereby news is recorded and published by individuals from those localities, thereby establishing a “local newspaper” for any location in the country available to the general public. It uses a compensation formula to incentivize small independent publishers and local business advertising in each community.

The MLM news affiliation allows a “crowd” of local small time reporters to spontaneously report on any news of their choice without requiring direction or approval from an organizational entity. Members are sponsored into the MLM by someone they know who becomes their sponsor, mentor, and editor. In turn, the new member may choose to sponsor someone else they know into the MLM. The MLM provides a compensation plan providing incentive for members to sponsor new members and new members to join. Sponsors enjoy a bonus compensation dependent on the performance of their members, so there is an incentive to support and manage members. The sponsorship responsibility provides a distributed management functionality to the MLM organization. The invention's technology enables distributed “hiring” and “management” to proceed without any centralized direction or overhead costs of a traditional, centrally managed, organization thus solving the business challenge of acquiring resources to cover small local news.

The members of the MLM, subscribed readers, and advertisers use MANA to communicate with News Distribution Service (NDS). The application can be used to report news using NEDS as well as provide continuous device location data. The NDS provides Location Applicable News Alert (LANA) to devices running MANA. The alerts can provide real-time news specific to location such as a police situation down the street or an accident on a road historically traveled. In addition, a reporting member's sponsor can be alerted to the posting so they may exercise their role as a “managing editor” to improve reporting or mitigate any issues such as legal or ethical transgressions. The invention's technology enables real-time news and distributed “managing editors” without any centralized direction or overhead costs of a traditional, centrally managed, organization thus solving the business challenge to coordinate faster news distribution.

There is no source for local news in the majority of localities in the United States that is available to the general public. Local news is still disseminated by word of mouth to friends and family, written letters to friends and family or electronically communicated (e-mail, facebook, twitter) to friends and family. Our system enables any geographically segmented area to have a “local newspaper” that will report the news to the general public.

Our invention transforms the current news reporting process into a new and useful system for reporting news in small and medium size communities. Multi-level marketing is transformed into multi-dimensional marketing by introducing a geographic dimension, whereby compensation pools are created based on geographic areas; and a new product creation dimension, whereby article compensation credits are created by creating new “news content” which is the product of the process.

Our invention is an unique system to describe, record, categorize and archive physical events in communities utilizing words, pictures and videos and provide this information to the general public through a central portal able to access all communities, thereby creating a newspaper for any community available from a general purpose computer.

No product or service like this exists in the marketplace today. It would be useful and transformative to the news industry by providing the general public unique access to news in small and medium size communities, by providing individuals of small and medium size communities an unique outlet to report local news to the general public, and by providing businesses of small and medium size communities an unique outlet to advertise to their community.

In this invention the following transformations take place due to the system applied:
Local physical events are transformed into articles of record via news articles written by members of a multi-level marketing network organization.
The news articles are entered into a records database using general purpose computers or electronic device running web browsers as well as other media recording devices.
Independent news content when combined with other independent content from the same geography and then further combined with geographic regions throughout the country are transformed into a centralized community news service by dissemination on an internet for any locality available for the general public to read.
Using the multi-level marketing network organization transforms individuals and groups into independent publishing entities at multiple levels for the purpose of compensation as in previous multi-level marketing organizations. The entities are further segmented by geography into compensation pools where advertising revenue and publisher compensation are balanced by a formula.
The use of a multi-level marketing organization is used to transform the high cost linear management structure of tradition news services into a low cost distributed management structure where upper level members are responsible for managing their down line members in an independent manner.
The use of a multi-level marketing organization is used to transform the high cost of full-time publishers into a large pool of low cost independent publishers which may be smaller part-time publishers.
Multi-level marketing is transformed to multi-dimensional marketing by adding geographic and content based compensation pools.
Marketing advertising to local businesses transforms from an individual transaction to a comprehensive system to fund the community news services throughout the country by the cumulative impact of advertising throughout the country, thereby providing the primary funding source for the overall news organization.
Disseminating the content through the internet and a general purpose computer or electronic device transforms the computer or device into a machine providing comprehensive online local news for any locality accessed through a central portal.
A stand-alone action of a reader rating the content on an individual article is transformed into a critical action as a part of the self-regulating process, by using the cumulative ratings to monitor and manage the content and contributors across all localities.

When standing alone, these actions do not provide any new state or thing. When these actions are combined into a series of actions, they create a new and useful system to transform the current news reporting for small and medium size communities by increasing the availability of content, providing a funding source for the contributors, providing a portal for the general public to access multiple localities, and provides a rating system to regulate the content of the local newspapers.

We believe that the system created by the combination of these actions is not obvious.

Improving the level of local news and using independent content has been an objective of many organizations for several years. These organizations are highly skilled in the matter. However, they have been unable to develop a system to motivate individuals in a community to actively participate and provide independent content to their organizations.

Multi-level marketing companies have existed for over 50 years. Just about every product and service has been offered through a multi-level marketing organization. However, all of these organizations are 2 dimensional in their structure. The first dimension is the selling of a product or service to customers. The second dimension that provides the accelerated growth potential in multi-level marketing is to recruit others to do the same, thereby creating multiple (multi-) levels of sales people that can earn compensation from their downline. These organizations are highly skilled in the matter. However, they have never considered “news” to be a product or service that fits with multi-level marketing because it is constantly changing and not well suited for the resale environment of the multi-level marketing structure. They have not attempted to utilize a third dimension to be able to create geographic compensation pools or new product creation compensation pools, whereby news content is constantly created and members are compensated for it.

Many current news services allow readers to rate their news articles or comment on their news articles. These are used to let other readers know the opinions of previous readers. No current news provider utilizes the ratings to remove articles, block content contributors, or help in calculating compensation for their content contributors. These organizations are highly skilled in utilizing online ratings. However, they have not introduced a system to use the ratings to self-regulate the news service. They also do not use the ratings to remove articles for false or misleading material, or ban content contributors from writing more articles if they offend to many times, and the ratings are not used in the compensation calculations for the content contributors.

Currently there are news services in some small communities that only provide independent content for their own community. These organizations are highly skilled in setting up a local website. However, these organizations have gained little traction because they have been unable to motivate residents to contribute content and the content that is available is primarily opinions or in blog formats. The websites are also not linked to any other community's website. So a reader would have to search the internet to try to find these individual community websites. These small, start-up sites have been unable to develop a system to join together to create a centralized portal for the general public to quickly and easily find their local news.

The claims are intended to point out the distinct system of the “creation of an independent community news service” and the “creation of independent publishers”, whereby the system of combining multi-dimensional marketing, independent news content, a central portal, advertising, and a general purpose computer or electronic device transform the individual parts into a new and useful system to provide all communities with the ability to create their own local newspaper accessed through a central portal. The individual parts also combine to transform the independent content contributors into independent publishers for their content.

The statutory matter in this invention is the “system” created that transforms the individual parts into a new and useful system to provide all communities with the ability to create their own local newspaper accessed through a central portal. Since the use of a general purpose computer or electronic device is transformed into the publishing medium and a reader for the local newspaper, this could also be considered a “machine” for statutory purposes.

The combined parts do provide a new and useful purpose, whereby community news services are created.

The multi-level marketing network and multi-dimensional network will also be known by “network publishing organization” and “network marketing” in this patent application. An independent member of this multi-level marketing network service will also be known by “LIP” (Local Independent Publisher) in this patent application.

### DRAWINGS

### Figures

In order to assist the understanding of this patent application, reference will now be made to the appended drawings, in which like reference characters refer to like elements. The drawings are exemplary only, and should not be construed as limiting the patent application.

FIG. A-1 Multi-level marketing network business structure will be used for recruiting independent publishers to create content and sell products and services.

FIG. A-2 Content created will be at the community level and will be segmented by geographic criteria, such as zip codes, area codes, city name, county name, etc.

FIG. A-3 Independent, unlimited, local news will be created for every community.

FIG. A-4 This news content will be created, categorized, and disseminated online with electronic devices.

FIG. A-5 Advertising space will be sold by members of the network marketing group.

FIG. A-6 News content and advertising will be disseminated throughout communities across the country utilizing the internet with electronic devices.

FIG. A-7 Revenue will be created by these independent publishers selling advertising and services, and by recruiting other independent publishers to sell advertising and services as well, utilizing the multi-level marketing network structure.

### DETAILED DESCRIPTION & OPERATION OF EMBODIMENTS

Reference will now be made to the system of this application.

The Concept of the Patent:

FIG. A-1 highlights the embodiment of utilizing a multi-level marketing network structure for operating an online news service. This system provides an opportunity to any citizen in a community to start their own publishing business by creating news content, developing news sources, selling advertising services, and recruiting other citizens to do the same. Applying this system to the online news industry solves many of the problems of the current news industry discussed in the background of prior art. It creates an opportunity for unlimited number of citizens to become reporters, publishers, recruiters and advertising marketers. And most importantly, it provides a system supporting compensation for their efforts.

In the business structure shown in FIG. A-1, there is a multiplication effect of recruiting more and more individuals to start their own business and become local independent publishers, whereby more news content is created, more news sources are called upon, and more advertisers are solicited. There are no limitations to the number of citizens that can become involved in news services. There are many variations of compensation plans from one multi-level marketing group to the next. However, the core structure is the same. An individual becomes a member of the multi-level marketing network starting their own business selling products and services for that company. That member gets paid a percentage of the revenue dollars they are directly responsible for developing. That member can earn additional income by recruiting other individuals to become members of the multi-level marketing network and starting their own business as well. They then earn a percentage bonus based on the amount of business done by the group of members they recruited. As shown in FIG. A-1, the member on the first row recruits multiple individuals to be members, members in row 2 also recruits multiple individuals to be members, members in row 3 and below continue to repeat this recruiting process. In this structure an unlimited number of individuals in a community can be local independent publishers, reporters of news, recruiters of centers of influence to provide news, and sellers of advertising and related services to provide revenue for the news service.

Another embodiment with this system of recruiting and building a marketing structure for online community news services, is that it will enable every community to have a news website focused on their local news, created by their citizens and funded by advertising from their local businesses. As shown in FIG. A-2, there are thousands of different zip codes in the United States. With this system each zip code can have their own news service. A network of members created by a network marketing organization will enable any geographical area to develop their own, self funded, news service. This service can be segmented by any definable geographic metric, such as: Zip code, area code, county, city, township, and neighborhood.

FIG. A-3 is representative of the local news service that can be created by this system. This news service can be unlimited and available in all communities. As discussed in the background segment of this application, news services today are limited to larger cities and towns and are limited by the amount of news they can create and distribute. This system of news creation overcomes all the limitations of the current news business. A community can have a news service that covers everything from a neighborhood meeting to a town hall address or from a little league baseball game to the local high school playing in a state championship. All citizens of a community have different interests and different sources and access to news. When these citizens come together on a common website, based on their geography, to share their news and interest, then a local news service is created. Teachers, coaches, politicians, administrators, yard sale organizers, store owners, public works employees, emergency services employees, tour guides, and any other person in a community can share the news that they possess about their local community. Limitations on the type of news or events and limitations on the amount of information that can be shared are removed. All citizens can join the network marketing group and become reporters for their communities.

FIG. A-4 depicts the common computer or electronic device that the majority of citizens have in their home or workplace. This system of news delivery is dependent on the utilization of modern computing. There is no need for expenses like a printing press for newspapers, transmission equipment for a radio station, or a studio for a television station to provide a local news service. Traditional news delivery only makes economic sense in larger towns and cities. Citizens that become members of the network marketing group will enter and organize their news reports on their computer or electronic device. Citizens that are reading their community's news will be reading it on their computer or electronic device. With this system of delivery there is no capital commitments on either the reporters, advertisers, or the readers to purchase equipment. Technology in place is utilized by local citizens to create and disseminate local news for their communities.

An additional embodiment of this system of local news delivery by a networked marketing group is its ability to be self funded. FIG. A-5 is an illustration of advertising that will be the primary funding source of this service. The current news services that are attempting to provide independent local news online are not having success because they do not provide funding to their reporters. This system combines local businesses, local reporters, local readers, and local network marketers. The network marketers will sell advertising space on the online news service. Local businesses in small communities have very few choices of where they can advertise. This service will provide local businesses in all communities an opportunity to advertise to a target market of citizens of their own community. They will also be able to target their advertising based on a reader's interest and categories of news. This advertising spending will provide funding to pay for local citizens that report news and for local network marketers to run their business.

FIG. A-6 is representative of the internet. The internet will be used as the distribution mechanism to deliver independent local news and local business advertising. The viral aspect of the internet enables an unlimited reach of local news from each community to all members of that community or to anyone else in the world with internet access. The internet also provides a cost effective distribution of the local news and advertising for local businesses. Local news stories can be distributed to all citizens of the community at the push of a button. Local businesses can advertise their products and services directly to the citizens of their community. These news stories and advertisements can be viewed by an unlimited number of people over an unlimited geography due to the ubiquitous nature of the internet. Reader ratings provide feedback to enable a self regulating mechanism. The system of network marketing produced news content and advertisements distributed over the internet, creates an online local news service for any community that wants to start one.

FIG. A-7 is representative of a profitable business opportunity. Local news services do not exist for every community because it is not economically feasible to operate a traditional news service in small cities, towns and communities. Internet sites that are trying to create local news services currently do not provide a financial incentive for citizens to report news and sell advertising. The system of this idea compensates members of the network marketing organization for creating news content, selling advertising, and recruiting others to do the same. The multiplication effect of the network marketing structure becomes exponential creating a large, financially motivated, network of members providing a self funded local news service in every community. Citizens of each community will have the opportunity to join the network marketing group and have the financial incentive to create news and sell advertising to local businesses.

Network marketing groups and the internet share one very important characteristic. That is the ability to multiply and spread very quickly. This combination provides an opportunity to put in place a news service that has more local content, geographic reach and financial potential than any news service in history.

### DRAWINGS

### Figures

FIG. B-1 This flow chart illustrates the flow of information, services and monetary payments.

### DRAWINGS

### Reference Numerals

### Reference Numerals for B-1

Numeral 1 represents local businesses that will advertise on the online news service.
Numeral 2 represents the payment from local businesses for advertising services.
Numeral 3 represents the advertising service that will collect payments and create advertising content for the online news service.
Numeral 4 represents the sales activity of the LIP's to sell advertising space on the online news service to local businesses.
Numeral 5 represents the order that the LIP's will place with the advertising service to create the advertisements.
Numeral 6 represents the records that will be used by the service to track who sold the advertisements for compensation purposes.
Numeral 7 represents the advertisements created by the advertising service that will be displayed on the news service's publishing web site.
Numeral 8 represents the Local Independent Publishers (LIP's) who will be the independent network marketing business people.
Numeral 9 represents the payment that will come from the online news service to the LIP's for their commissions and bonuses on sales.
Numeral 10 represents the payment system used by the network marketing organization to calculate commissions and bonuses for the LIP's.
Numeral 11 represents the information that is received or created that will become news for the service.
Numeral 12 represents news articles that are created by the LIP's to provide news for their local news service.
Numeral 13 represents the cumulative ratings that readers of the local news service will give each article and author that publishes news stories. This will be used in the calculation of commissions and bonuses for the LIP's.
Numeral 14 represents the local citizens that will read the local news, provide comments and ratings, and sometimes provide news tips to the service.
Numeral 15 represents comments and ratings on articles and authors that the local public will provide when reading the news service.
Numeral 16 represents the news articles and advertising that will make up the news service for local communities across the country.
Numeral 17 represents the publishing web site that will be the hub web site for all the local news services.

### DETAILED DESCRIPTION & OPERATION

Flowchart of the Structure of the Idea: B-1

An alternative embodiment is the development of a multi-level marketing network publishing system. The system of this patent application enables every community to develop a news service under the structure illustrated in FIG. B-1. The following description will highlight step by step where the flow of information and money takes place.

Reference numeral 1 represents a plurality of local businesses in each community that would have an interest in targeted advertising to citizens of their community. Reference numeral 2 is the flow of payments for advertising. This is from the local businesses to the advertising services department of the network marketing organization. Reference numeral 3 represents the department at the network marketing organization that will be responsible for servicing and inserting the advertising into the pages of the news website. Reference numeral 4 depicts the sale of advertising services by a Local Independent Publisher (LIP), which is a member of the network marketing group. The independent members will earn a retail margin by selling advertising to local businesses in their communities. Reference numeral 5 denotes the order for advertising services. The order will be sent directly to the advertising service department of the network marketing organization from the LIP and the advertising services department will collect the payment as shown in reference numeral 2.

Once the advertising is sold, the advertising services department will provide record of the sale to the payment department for the calculation of commission and bonus for the LIP's. This record delivery is illustrated with reference numeral 6. Reference numeral 7 shows the insertion of the advertisement to the news publishing website. The advertising department will provide the advertisement and data needed for the placement of the advertisement onto the website. This data will provide the format of the advertisement, the zip code or geographical information on where the advertisement should appear, the news categories on where the advertisement should appear, and any other pertinent data.

Reference numeral 8 is representative of the Local Independent Publisher (LIP). There will be an unlimited number of LIPs. As shown in FIG. A-1, the organization will be made up of a network of independent marketing representatives, also known as HP's. Each of these LIP's/representatives will develop their own business by selling advertising and related services, writing articles, recruiting others to write articles and recruiting others to start their own independent publishing business within the network marketing organization. Reference numeral 9 shows the payment of commissions and bonuses to the LIP's. By selling advertising and related services, writing articles and recruiting others to write articles, and building a network of other publishers, the LIP's will earn commissions and bonuses from the network marketing organization. Reference numeral 10 represents the formula used to calculate the commission and bonus for the LIP's. The calculation will be performed by the network marketing organization's administrative segment. A sample formula of how the calculation could occur is demonstrated in FIG. D-1 of this patent application.

Reference numeral 11 is representative of the flow of news, current events, or pertinent information that will make up the content of the online news service. In every community there is news and information that is passed from person to person by many informal means. This system is designed to formalize the passing of news and information that is organized to enable every person in that community to have access to all relevant news and information in their community. This flow of news and information is the backbone of this service. Everyone in a community has news and information that they can share. The ability to pass it on is usually limited to word of mouth by telling one person or group who tells it to another, who tells it to another. There are also many sources for limited distribution such as: church or neighborhood bulletins, yard sale signs, fund raiser signs, construction postings, political meetings, sports team schedules, school newsletters, store sales, and many, many more. The audience for all of these sources of news and information can become unlimited with use of this online news service of network marketers.

Reference numeral 12 is the next critical step to creating an online news site that will be utilized by communities across the country. This is the process of turning local news and information into formal news articles that are published in an online multimedia format. Taking the information from the sources in reference numeral 11 and creating content for the news service enables a comprehensive news service to be created for all communities. Articles can be categorized into many areas of interest. LIPs that create the articles can classify them into one or more categories of interest, list them as fact or opinion, and list them as news or informational purposes.

Another embodiment of this patent application is to utilize a rating system to create a self regulated news service. This step in the system of creating a relevant news site is to allow readers to apply ratings to the articles. Reference numeral 13 and 15 are representative of these ratings. The local citizens or local public, shown in reference numeral 14, will be the consumers of this news service. The consuming public will be able to rate each article and comment on the content as shown by reference numeral 15. The ratings can consist of: accuracy, level of interest, timeliness, locally focused, quality of reporting, as well as others. These ratings will be used in the calculation of commissions and bonuses that LIPs will receive in their network marketing business. This is illustrated by reference numeral 13. The ratings input into the website will be relayed to the department that calculates this compensation. The ratings can be given a different weight in the formula to calculate commissions and bonuses. Also, the LIPs' compensation affected by ratings, can be on ratings a current article receives, cumulative ratings of all articles they've done over a specific period, and cumulative ratings of articles their group or members of their network marketing business have created. This rating system will serve as a form of self regulation of the news service for each community. If the LIPs do not create a good article, have a history of not creating good articles, or their group is not creating good articles, then their commissions and bonuses from their network marketing business will be less than those who are producing good content.

Reference numeral 17 is representative of the web site of the network publishing organization. This is the hub of the online activity for the organization. Content coming into the site includes articles, advertisements, comments and ratings. The end product is the outgoing content that makes up the news services for each community. Reference numeral 16 is representative of the news and advertisements that the consumer sees when they access the online news service for their community. One objective of the idea behind the patent is to create a central website that becomes a portal for all communities to have a credible, comprehensive, relevant online news service. Another objective is for it to be self funded and self regulated. The system utilized in the website will take local news, information, and events from around the country and organize and distribute it to anyone with an internet connection.

The publishing website provides the ability for all the community news services, created by this patent application, to be accessed from one central website. Just as a consumer would pull up Google, Yahoo or Bing to start a search for information on the internet, a news consumer will pull up the publishing website to search for news and information for their community. Segmentation by geography and interest of the content provided to the news service allow for ease of use for citizens in each community as well as others that want to read news about other communities to all start from one central website.

### DRAWINGS

### Figures

FIG. C-1 This diagram illustrates the interaction of systems to connect independent publishers, advertisers, readers and consumers within a community with a networked computer system.

### DRAWINGS

### Reference Numerals

### Reference Numerals for C-1

Numeral 1 represents database servers that will be used for storing data and content for the business and news service.
Numeral 2 represents the application servers for the news website.
Numeral 3 represents the application servers for the advertising services website.
Numeral 4 represents the application servers for the publishing website.
Numeral 5 represents the browsers that will be used by the general public.
Numeral 6 represents the browsers that will be used by the local businesses.
Numeral 7 represents the browsers that will be used by the local independent publishers.

### DETAILED DESCRIPTION & OPERATION

Use of Computer Hardware and Software: C-1

Another embodiment of this system of news delivery is the use of computer hardware and software to bring together all the participants in the networked news service. This interconnectivity is illustrated in FIG. C-1. Reference numeral 1 is the database level where the data is gathered and accessed from the publishing website, the advertising services site and the news web site. This information will be sorted and organized by the application servers. Browsers access the application servers both for data input and formatted data viewing via dynamic web pages.

The customer advertiser database includes three associations. The first is the news web site server. Localized viewer information and history can help determine the best advertising presentation. The second association is the advertising services site server. This advertising data includes who the advertiser is, what they want to advertise, where they want their advertisements to appear, when they want their advertisement to be displayed. The third association is with the publishing web site server. Published content and category keys may help select targeted advertising matches. All advertisement on the news service is the result of LIPs marketing to local businesses. Therefore each advertising contract will be assigned to the account of the LIP that sold that business. This data will keep track of the relationship between advertisers, LIPs, network groups, and the news service operations.

The Zipcode news database has two main associations, the news and publishing web sites. The association of data between the zipcode news database and the news web site is primarily news content. All news and media are served from the database. The public viewers of the news service provide information on their preferences such as geography and category of news stories. The publisher site organizes LIP relationships with news stories based on author, geography and category of news.

The publisher database contains data associated with publisher activity at the publishing web site and readership feedback from the news web site. All LIP publishing records are stored there and associated with reader inputs. The public can also provide ratings on the news stories and comments which become associated with the content author.

Reference numeral 2 is the application server for the news web site. This server constructs the web site utilizing the data stored in the news database. At the application level this information is segmented and displayed by geography and category. This application server will also pull data from the advertiser database and publisher database. The news site will integrate news articles, advertisements, reader's ratings, commentary, and other publisher site links for the final view for the public. All of these components can be segmented based on viewers' preferences of geography, category, ratings level and other criteria created by the news organization.

Reference numeral 3 is the application server for the advertising services site. This server will execute several procedures to provide support for the advertisers, links for the public, and data for the LIPs. These procedures would include but are not limited to the following. Advertisers can provide links to their own website so users of the news website can click through to the advertiser's website via the link. These links will be stored in the customer advertiser database and pulled from this database at execution of the activity. Advertisers' ad formats will be constructed at the application level. This may include pictures, data, video, and/or voice for the construction of the final ad to be displayed. The content to create and form the advertisements will be stored in the customer advertiser database and will be pulled from the database server as web pages are created for the news service. Services to the advertiser will also be executed at this level. Advertisers can check the number of hits their ads are receiving, the number of click-throughs, the number of page views they are receiving and other quantitative measurements for their ads. Qualitative measures can also be tracked by the advertisers such as the demographics and geography of the viewers that are hitting their ads or accessing their links.

The advertising application server will provide links for the local public. When the local public is viewing the news website they will see links to the local businesses. The application server will execute the process of directing the local public website user from the news website to the advertiser's website. The LIPs will utilize the advertising application server for tracking their advertising clients' activity and for tracking their own business metrics related to advertising revenue. All of the metrics and activity listed in the above paragraph for the advertisers, can be tracked and monitored by the LIPs as well. The tracking and monitoring of the advertising business will be executed at the application server level. The network marketing organization, the LIP's groups, and the LIP's individual advertising activity will all be executed, tracked, monitored, and recorded for the establishment of business credit to each individual and group in the organization.

Reference numeral 4 is the application server for the publishing network web site. This server constructs the web site for the LIPs. The LIPs will utilize this site for their news publishing and business information. The server will process data between the zip code news database, the customer advertiser database and the publisher database. This site is the primary content publishing mechanism for editing and media uploads. This site will also be used to run the business side of the network publishing organization. LIPs will utilize the data from the news database to track their group's content of news articles, the placement of those articles and the number of views from the public. They also will be able to track the ratings their group is receiving on those articles based on various metrics such as accuracy, importance, and timeliness. The LIPs will use the data from the advertiser database to track their network group's list of advertisers, the advertisement's design, location, number of views, number of displays, and other metrics created by the network publishing organization. LIPs will use data from the publisher database to track the metrics of their own business and their group's business. This data will include the number of members in their group, the number of articles they published, their group's ratings data, the percentage of their individual and group's business to the overall organization and to the geography of their business to calculate their share of revenue for their business.

Reference numeral 5 is representative of the final product of the idea. The local public will see an independent, online, local news service. The public site browser can retrieve information from the news web site application server and from the advertising services site application server for presentation of the content as local online news web pages. The browser will present the news in formats that are separated by geography, category, special interests, and chronology. While the main site for each geography will be in this standard format, viewer specific preferences may also be customized to present the information in varying formats. For instance, a public user with children may have preferences for a site focused on the youth activities in their area. They can input settings that would highlight the news of youth sports, school news, children's community activities, etc. The news site would also be programmed to include appropriate adverting with these preferences. For instance, the advertisements presented by the browser may be a local sporting goods store, local museum, local arcade, local ice cream stand, etc.

Electonic devices connected to online communication networks like the internet will enable every community in every part of the country to have their own customized, local, online news service. The web pages will be populated with local news, from local people, and local advertisements, from local businesses. The browser will be retrieving links to present in the web pages so the local public can link to the local websites of businesses, organizations, and associations. Another system created by this idea is a rating system that is self regulated. The browser will enable the public to rate and monitor the news based on various criteria. This may include accuracy, timeliness, level of importance, and level of interest. The content of the news service will be displayed based on the ratings of the public. And articles and authors may be removed from the service if their content proves to be inaccurate or offensive.

Reference numeral 6 illustrates the browser for the advertisers. This browser will retrieve data from the advertising services site application server. The browser will present the data in a format intended to inform the advertisers of the quantity and quality of their advertising. The browser will also segment the presentation of web pages for advertisers by geography, category, and chronology. The advertisers will see the number of hits they have received, the number of page views, the number of unique visitors, the number of click through's on their links, and advertisements' format. Advertisers will be able to use this browser to communicate with their LIPs for various business services. These orders may include changing the content of the advertisements, the placements of advertising, the quantity of advertisements, and the payment for their advertising.

Reference numeral 7 is the browser for the LIPs. These Local Independent Publishers will interface with this browser to run their business. Here, the browser is the primary content input and editing tool. Expanded media like pictures and video will be uploaded through the browser interface. The browser will retrieve information from the advertising services site application server and the publishing web site application server. The browser will present the information in a format that can be customized by each LIP. The LIP will be able to track their personal business sales, their group sales, their group bonuses, and their incentive bonuses. They will also use the website to track their direct customers' advertisements and their group's customers' advertisements. In addition to monitoring the advertising activity of their group, the browser will provide them a format to track the citizen reporters that are creating articles within their group. LIPs can see the number of reporters, articles, ratings, hits, unique viewers and other metrics of their business.

The claimed invention is like a big news generation machine. It is formed by a network of computers operating in parallel providing a plurality of input channels for publishing and a plurality of output channels for news. Since news is fleeting in nature, old news is of no value. Only the speed of these networked computers and the vast expansion of inputs and outputs enable an improved news generation, as timely, decentralized, independent, self-regulated, and voluminous. As news is copyright eligible material it can be referred to as intellectual property. This news machine provides a new way to generate a higher value type of this intellectual property that can only be realized with computers networked and coordinated as described in the application. As such the system is significantly more than any single computer could generate and would be impossible to do manually with paper and pencil.

### DRAWINGS

### Figures

FIG. D-1 This diagram illustrates the payment system that will provide the customers for the advertisers, the advertisers for the news service, the revenue for the network publishing organization, and the compensation for the LIP.

### DRAWINGS

### Reference Numerals

### Reference Numerals for D-1

Numeral 1 represents the consumer of the news service.
Numeral 2 represents the customers of the local businesses.
Numeral 3 represents the local businesses that will advertise on the news service.
Numeral 4 represents the network publishing organization that will operate the news service and the network marketing organization.
Numeral 5 represents the multi-level marketing network group that each LIP will develop for their businesses.
Numeral 6 represents the calculation formula for the commission and bonuses for the LIPs.
Numeral 7 represents the LIPs that will receive commissions and bonuses for creating news content, selling advertising, and develop a network marketing business by recruiting other LIPs to do the same.

### DETAILED DESCRIPTION & OPERATION

Payment System: D-1

FIG. D-1 is another embodiment of this patent application creating a self funded news service and business opportunity. This system of the flow of payments creates a profitable, self funded news service and a business opportunity for local independent publishers to start their own network marketing business.

Numeral 1 represents the end consumer for this news service. This news consumer will utilize the service to gain access to local news content. This consumer will provide 2 critical elements to the payment system. First and most importantly they will view the advertising of local businesses that are advertising on the new service as they are reading the local news content. This may develop the news consumer into a referred customer for that local business. The second important element they provide is the rating of the news content they are viewing. The ratings they provide on the news content will be utilized in the commission and bonus calculation of the publishers that provided the content. Low ratings will decrease the amount of the bonus for publishers. So publishers will make an effort to ensure that their content is accurate, timely, and interesting.

Numeral 2 represents a referred customer of the news service. The reason companies advertise is to gain more customers and business. Referred customers of this local news service will purchase products and services from the local businesses that are advertising on the news service. The increased business for the local businesses will enable them to continue or increase their advertising purchases on the local news website.

Numeral 3 represents the local businesses that are advertising on the news service. These local businesses will make payments to the network publishing organization in order to advertise on the news service. These payments for advertising services are the primary source of revenue for the news publishing organization and the news service. The location of the advertisers will help determine commission and bonus calculations for the network marketing business. The pool of advertising dollars from each location will be used to compensate the LIPs in that same geographic location. While advertising will be the primary source of revenue for the service, other revenue sources may include business services, such as web hosting, demographic analysis, enhanced marketing or any other additional services offered by the network publishing organization and sold by the LIPs to the local businesses.

Numeral 4 represents the network publishing organization. This is the corporate entity that will operate the news service, maintain the database records, administrate the network marketing groups, calculate the commissions and bonuses, and provide payment to the LIPs. In maintaining the central database of records, the network publishing organization will make payments to the LIPs based on the data from the news service, ratings, advertisers, LIPs' individual sales, and LIPs' group sales. The commissions and bonuses will be calculated utilizing this data which will be further described in numeral 6.

Numeral 5 represents the multi-level marketing group. This is the business model that will be utilized to enable the news service to grow rapidly and reach every community. LIPs will recruit other individuals to become LIPs. The role of all LIPs will be to sell advertising, create local news content, and recruit others to do the same. In doing so, each LIP will develop a multi-level marketing group of LIPs that join the organization under them. Each LIP will then have advertising sales that are attributed to their group and news credits that are attributed to their group. These group sales and news credits will be utilized by the network publishing organization to calculate a group bonus that each LIP will receive. The size of each LIP's group and amount of revenue produced by that group will determine the level of bonus. As in existing multi-level marketing organizations, there will be a sliding scale to determine the percentage of group bonus that each LIP receives.

Another embodiment of this system of news delivery is the utilization of a multi-level marketing network payment structure.

A MLM is a distributed organization with many levels. New members of the organization are at the bottom level and is “downline” from their “upline” member who is the member which recruited them. When a bottom level member recruits a new member, the previous bottom level member rises a level since they become a new “upline” for the new member who is a bottom level member and part of the “downline” group for the new “upline”. Our MLM concept establishes a group business volume for an “upline” member to include the sum of the business volume of the “upline” member and the business volume of the all associated “downline” members. The group business volume is used to establish tiered percentage bonus commission levels for the “upline member”. The bonus commission is determined by multiplying the achieved tier of percent bonus by the upline member's personal business volume. In addition, once an upline member's group volume reaches a higher level tier, a residual bonus is determined by multiplying the residual tier percentage by the whole group business volume. The total bonus is the sum of the bonus commission and any residual commission.

Numeral 6 represents the calculation of the commissions and bonuses for the LIPs and their network marketing group. The information used for this calculation is gathered from the database of the network publishing organization, the individual advertising sales and news credits, the multi-level marketing group sales and group news credits, the ratings on the news content, and the geographic location of the advertising. When revenue is received at the network publishing level, it will be segmented into categories to pay expenses. Examples of these would be categories such as: wholesale services payable to the network publishing organization, commissions for the direct seller payable to the LIPs, a bonus pool for the multi-level marketing groups payable to LIPs, and article bonuses for contributing news articles to the news service.

The wholesale revenue remains with the network publishing organization. This revenue will fund the operations of the news service. The commission revenue will be paid directly to LIPs for any products or services they personally sold. The revenue allocated to the bonus pool will be used to pay group bonuses to LIPs based on the total business volume of their personal network of LIPs. The revenue allocated to the article bonus will be used to pay LIPs for news credits and ratings they and their groups achieve.

The commission portion of the payment system is derived from the individual advertising sales and any other business services sold directly by the individual LIP. The payment system will pay a set percentage of revenue directly to the individual LIP that was responsible for the final sale to the business that purchased the services. The bonus portion of the payment system will also come from a set percentage of the total revenue of the news service. This pool of money will be split among LIPs based on how much revenue was produced by their network marketing group and may be adjusted based on volume and ratings of news articles in the group. The more revenue a particular LIP's group produced the larger percentage of the bonus pool they will receive. Advertising credit is earned as a direct sales commission. Each advertising sale contributes to a personal business volume. Each member that has sponsored member(s) in the multi-level marketing group accumulate the business volume of all their down line members for the purposes of calculating a bonus level and associated percent bonus according to the sample bonus schedule of the application.

If $1 million of revenue was produced by the news service in one month, it might be categorized and distributed as follows:
Example purposes only (formulas within this patent application are not intended to be the actual formula used in practice or to limit this patent application based on these formula examples, they are only included to illustrate how the payment system could work)

| | |
|---|---|
| 40% wholesale | $400,000 to the Network Publishing Organization |
| 20% commission | $200,000 to the LIPs for direct sales |
| 30% bonus pool | $300,000 to the LIPs for their group's business volume |
| 10% article bonus | $100,000 to the LIPs for creating news articles |

The bonus pool portion will be distributed by a formula determined by the network publishing organization. The formula will be structured to incentivize each LIP to build a network of other LIPs thereby building a network marketing business. The amount of business volume each LIP's group produces in a specified time period will determine how much of the bonus pool will be paid to each LIP for maintaining and growing a network marketing group of LIPs.

If $300,000 is allocated from the above example for the monthly bonus pool, it might be distributed based on the following hypothetical formula.
Example purposes only (formulas within this patent application are not intended to be the actual formula used in practice or to limit this patent application based on these formula examples, they are only included to illustrate how the payment system could work)

Group business volume for the month:

| | |
|---|---|
| LIP with group business | 5% bonus |
| volume of $500 or more | |
| LIP with group business | 10% bonus |
| volume of $1,500 or more | |
| LIP with group business | 15% bonus |
| volume of $3,000 or more | |
| LIP with group business | 20% bonus |
| volume of $5,000 or more | |
| LIP with group business | 25% bonus |
| volume of $7,500 or more | |
| Finders Fees | 5% additional bonus (Any |

LIP that directly recruited a LIP that achieves 25% bonus level will receive an additional 5% finder's fee bonus for that LIP.) This 5% finder's fee will continue to be paid to the LIP that directly recruited the LIP that achieved the 25% bonus level, as long as the directly recruited LIP continues to achieve the 25% bonus level. If the recruited LIP falls below the 25% bonus level, then the LIP that directly recruited them will no longer get the 5% finder's fee and the scaled bonus structure for business volume, previously described in this patent application, will be used instead.

The more business the LIP's group produces, the higher percent bonus they will receive. As stated, the formula will be structured to incent LIPs to grow their group business. However they will also have to produce personal sales and develop multiple LIPs below them. For example, if a LIP's group volume is $3,000 and they did not have any personal sales and had one LIP below them who is responsible for the $3,000, then the whole 15% bonus gets paid to the LIP below them that did the work. The LIP that did not have any personal sales that month and had one LIP responsible for the whole $3,000 in business volume would not make any money that month. This is the key differentiator between multi-level marketing network groups and pyramid schemes. In a multi-level marketing group, you only get paid if you are doing the work and producing revenue. If you are not, then the bonus money goes to the LIPs below that person that is doing the work and building their group. A LIP that joins the network marketing organization but never does anything, will not make any money just for being a member.

As an example, a LIP sells $1,000 in personal sales in the month and his/her group of LIPs under them had sales of $5,000. The $5,000 in downline group volume consisted of 5 LIPs each responsible for $1,000 each. The LIP authored news articles that had $300 worth of advertising revenue overall for the month displayed on those articles. Then the LIP in this example would receive the following in commissions and bonus for the month:
Example purposes only (formulas within this patent application are not intended to be the actual formula used in practice or to limit this patent application based on these formula examples, they are only included to illustrate how the payment system could work)

| | |
|---|---|
| Personal sales $1,000 (20% commission) | $200 commissions |
| Group business volume $6,000 | $1,200 group bonus |
| (20% bonus on the scale above) | |
| 5 LIPs in this LIP's group that each | ($250) payout to downline |
| had $1,000 in group business volume | |
| (5% bonus each on the scale above) | |
| Article bonus (10% of associated revenue) | $30 article bonus |
| | $1,180 income for the month |
| | (prior to any adjustment for |
| | news credits and ratings) |

Other inputs for the calculation of bonuses will be the news article credits and consumer ratings. The bonus calculation for each LIP will take into account the number of articles written by the LIP as well as the number of articles written by the LIPs group. Credits will be given in the bonus calculation based on the number of articles written and the readership or unique visitors to those articles. The bonus calculation will also utilize consumer ratings for the articles that are based on criteria already discussed in this patent application such as: timeliness, importance, accuracy, and quality. The group bonus and article bonus may increase or decrease for each LIP based on the number of articles written, the volume of readership, and the ratings on those articles.

The credits and ratings will be averaged for each geographic region and then each LIP's level of news credits and ratings for themselves and their groups will be compared to others in the same geography or reporting area. The higher a LIP's credits and ratings compared to the average, the higher their portion of the bonus pool will be. Conversely, the lower a LIP's credits and ratings, the lower their portion of the bonus pool will be. This is intended to incent the LIPs to provide high quality, accurate, timely and pertinent news articles to the news service. There will be specific calculations detailed to the LIPs for each component and what percent change it could have on their bonuses.

The average is updated in real time as ratings come in from readers. The weighting then is relative to this average value. A high rating is proportional to the average regardless of the absolute scale used. For example, a location may have an average rating 3 on a 10 point scale with only 2 ratings, 4 and 2. Then, a rating of 4 is relative and proportional as 4/3 of the total number of ratings, 2, gives a ratings weight of 4/3/2=0.66. The other rating of 2 gives 2/3/2=0.33. Weighting to the average is independent of the actual scale used. If the article credit was $100 available from this geographic pool, and the ratings adjustment was fully applied, the lower rated credit would be worth $33 and the higher rated bonus would be worth $66. The credits earned by each member summed across all geographic pools they have currently participated in are summed to obtain their contribution to up line business volume upon which the up line bonus is calculated from according to the sample bonus schedule of the application.

The general description above, for numeral 6, is provided to give a conceptual understanding of the commission and bonus calculations for example purposes for this patent application. And it is not intended to be a detailed description or to limit this patent in any way as to what the actual formula will be for the news service in practice.

Numeral 7 is representative of the LIPs that will be starting and running their own independent publishing businesses as a multi-level marketing network. They will sell business services to advertisers and write news articles for the news service. To build their network marketing group, they will recruit other LIPs to do the same. The compensation for their efforts will come through the Network Publishing Organization in the form of commissions and bonuses based on the volume of business they are producing, as well as the volume and quality of the news stories they provide to the news service.

### DRAWINGS

### Figures

FIG. E-1 News Event and News Alert System Architecture depicts the major components of the news event and alerting system. The NDS is the primary network service used by MANA. News events are collected and analyzed. Location and category features are compared to each MANA location and category preferences and alerts are generated.

### DRAWINGS

### Reference Numerals

### Reference Numerals for E-1

Numeral 1 represents a Publishing Web Site which is a network server responsible for receiving and processing news submissions and uses a database server for submission storage.

Numeral 2 represents the News Distribution Service (NDS) which is a custom software application running on a network server.

Numeral 3 represents a Public Key Service (PKS) which allows the storage, searching, and retrieval of MLM member public keys used for signing and encrypting news submissions.

Numeral 4 represents the reporting of news events using the News Event Data Structure (NEDS) from the Network Devices running the news application.

Numeral 5 represents the periodic location updates he let the NDS track the location of each enrolled network device.

Numeral 6 represents Other Data such as encrypted signature files, media files, and application updates.

Numeral 7 represents the Location Applicable News Alerts (LANA) which are generated when news proximity and category align with application preference parameters.

Numeral 8 represents a Network Device which runs the news application.

Numeral 9 represents Multiple Access News Application (MANA) which is a custom software application running on the Network Device.

Numeral 10 represents the Authentication Service which is used to manage the public key infrastructure (PKI) on the Network device.

Numeral 11 represents a Location Service running in the Network Device.

Numeral 12 represents Media Service in the Network Device.

Numeral 13 represents Authentication data link with an Authentication device.

Numeral 14 represents an external Authentication device.

Numeral 15 represents a News Link that may be referenced from LANA data.

Numeral 16 represents a News Web Site which is a network server responsible for serving out news items and uses a database server for item retrieval.

### DETAILED DESCRIPTION & OPERATION

Systems Interaction: E-1

FIG. E-1 is another embodiment of this patent application whereby News Event and News Alert System Architecture depicts the major components of the news event and alerting system. The NDS is the primary network service used by MANA.

Numeral 1 represents a Publishing Web Site which is a network server responsible for receiving and processing news submissions and uses a database server for submission storage. It is also depicted in item 4 in FIG. C-1. Example embodiments of the Publishing Web Site is an Amazon E2C Virtual Server running a web site and network service applications.

Numeral 2 represents the News Distribution Service (NDS) which is a custom software application running on a network server. The NDS collects news submissions and application location data. NEDS submissions are logged into a database for publication on the News Web Site. It is also responsible for generating alerts based on news proximity and category parameters. NDS may generate automated reports of a statistical nature when news patterns change. For example, a 50% increase in the weekly moving average for readership within a category within a geographical boundary would generate an automated statistical report of the news pattern change. An alert would include the link to the automated report. These alerts and reports help reporters seek stories of interest and help keep advertisers informed of local customer concerns for better advertising. The embodiment may extend to a collection of servers coordinated to provide the NDS capability over different geographical locations servicing subsets of connected Network Devices. A basic embodiment of the NDS scans received email from authorized MLM members for NEDS data and attached media and NEDS Signature files.

Numeral 3 represents a Public Key Service (PKS) which allows the storage, searching, and retrieval of MLM member public keys used for signing and encrypting news submissions. Public key infrastructure (PKI) is implemented in a device in the possession of the reporter. The PKI is used to validate reported news events and to verify the reporters position in the MLM organization. The PKI is used to sign a hash of the reported news event with the private key by the PKI device. This signed hash creates a signature record for the news report. The hash can be recovered using the reporter's public key and used to verify the news article has not been altered. In addition the signature record itself can be further signed by an authorizing entity such as an editor in the case of an editor review requirement for publication. The PKS and MLM keys enable the use of PKI in the system. Example embodiment of the Public Key Service are Synchronizing OpenPGP Key Server (SKS) software on your server. SKS is an OpenPGP key server that correctly handles all OpenPGP features defined in RFC 2440.

Numeral 4 represents the reporting of news events using the News Event Data Structure (NEDS) from the Network Devices running the news application. Example embodiment is a XML data package or a key:value text list in an email. A basic embodiment use the time and location data in Exchangeable Image File Format (EXIF) from an attached photograph combined with key:value text in an email.

NEDS Data Items:
1. NEDS ID
2. MLM Member ID
3. Member public key ID
4. MLM Sponsor ID
5. Sponsor public key ID
6. Title
7. Byline
8. News Text
9. News Media Filenames
10. Category Tags
11. Local Timezone
12. UTC Time-Date
13. Latitude
14. Longitude
15. Altitude
16. Azimuth
17. Elevation
18. Revision

Numeral 5 represents the periodic location updates he let the NDS track the location of each enrolled network device.

Location Update Items:
1. Local Timezone
2. UTC Time-Date
3. Latitude
4. Longitude
5. Altitude

Numeral 6 represents Other Data such as encrypted signature files, media files, and application updates.

Other Data Items:
(a) NEDS Signature File
(b) Encrypted NEDS file
(c) Media files
(d) Encrypted Media files
(e) Alert Preferences
(f) MANA updates
(g) New Member Request
(h) News Links Clicked

Alert Preferences Data Items:
1. Current Location: Collection (Category:Distance)
2. Collection (Specific Location: Collection (Category:Distance))

Numeral 7 represents the Location Applicable News Alerts (LANA) which are generated when news proximity and category align with application preference parameters. Example embodiment is a XML data package like Rich Site Summary (RSS) with extra fields for NEDS ID and Category Tags

LANA:
1. NEDS ID—ID assigned by database
2. Category Tags A list of categories or special functions
3. News Link a Universal Resource Locater (URL) to the News Web Site

Numeral 8 represents a Network Device which runs the news application. Example embodiments of the Network Device are a cell phone and a personal computer.

Numeral 9 represents Multiple Access News Application (MANA) which is a custom software application running on the Network Device. Example embodiments are a downloaded application, a pre-installed application, and a sub-part of a larger application.

Numeral 10 represents the Authentication Service which is used to manage the public key infrastructure (PKI) on the Network device. This service may be comprised of a Network Device application or an application interfacing to an external Authentication Device. Example embodiments are GnuPrivacyGuard (GPG) and Yubico Authenticator.

Numeral 11 represents a Location Service running in the Network Device. The service uses device geolocation API and network services to provide geolocation capability to MANA. Example embodiments use IP address, radio-frequency identification location tags, Wi-Fi connection location, Global Positioning System (GPS) and GSM/CDMA cell IDs.

Numeral 12 represents Media Service in the Network Device. These services may be used to create or display media. Example embodiments are photo camera, video camera, microphone, web browser and media players. The Media Service may also provide Location Service through media metadata such as the location data in the Exchangeable Image File Format (EXIF) in pictures or video metadata.

Numeral 13 represents Authentication data link with an Authentication device. Example embodiments are a USB connection, Near Field Communication (NFC), and Bluetooth radio.

Numeral 14 represents an external Authentication device. It is used to generate and store keys and certificates supporting cryptographic PKI. Example embodiments are Yubico's Yubikey and OpenPGP cards.

Numeral 15 represents a News Link that may be referenced from LANA data. Example embodiments of the a Universal Resource Locater (URL) like http://www.example.com/index.html.

Numeral 16 represents a News Web Site which is a network server responsible for serving out news items and uses a database server for item retrieval. It is also depicted in item 2 in FIG. C-1. Example embodiments of the Publishing Web Site is an Amazon E2C Virtual Server running a news web site.

Technology to Enable a MLM News Organization

NEDS contains MLM identification of sponsor and member and cryptographic keys for secure identification, authorization, encryption, and non-repudiation. A PKS public key id is associated with the reporter's MLM identity. For the purposes of MLM bonus calculations, the id can be used to find the upline MLM sponsor of a MLM member and the downline MLM group established by the MLM member's sponsorship of others.

MANA can be used to help sponsor a new MLM member. Anyone may download MANA to view news and receive alerts. MLM Members also use MANA to report news. A MLM member may sponsor a new member into the MLM easily using MANA. The new member activates the MLM joining function in MANA which use the Authentication Service to generate a new PKI key pair and the public key is emailed to the sponsor. Once the new member's identity is verified, the new sponsor uses MANA to cryptographically sign new member's public key and submits a New Member request to the Publishing Web Site. The new MLM Member ID and sponsor signed key are emailed to the new member using the email address in the submitted public key. The new ID along with the signed key enable MANA news submission capability for the new member. The signed keys build a web of trust across the MLM since each member is known by at least one other member, their sponsor. The updated keys are the listed on the PKS for NEDS verification.

MANA cryptographically signs NEDS news with the MLM member's private key for identification. A hash value of the NEDS is signed. The resulting NEDS Signature File sent as Other Data verifies that the member actually submitted the news since only the member could have signed it with the private key. It can be verified using the members public key obtained from the PKS. In addition, the signature verifies the hash value of the NEDS so it can be known that it has not been altered.

A supervised MLM member's NEDS submission may generate an alert to the MLM sponsor for approval. The MLM sponsor uses MANA to view and possibly edit the NEDS. The Sponsor then uses MANA to retrieve and sign the NEDS Signature File with the sponsor's private key to authorize distribution. Or, in the case of an edit, a new version the NEDS is submitted and the updated NEDS Signature File is signed. The automated alert, editing, and signing with MANA allow for a distributed real-time managing editor authorization capability within the MLM.

MANA enables MLM members to establish a web of trust by signing each others public keys. When MLM members meet MANA uses the Authentication services to verify each other's keys with the PKS. Once a member is satisfied that the identity and key information match the other member, MANA will sing the other member's public key, encrypted it to the other member, and email a copy of it to the email address in the key. Once the email is received, MANA assists with decrypting the updated key and updating it on the PKS.

MANA may use the MLM member's private key for encryption of NEDS. Encryption mode may be used to prevent snooping on the news submission by network service providers. It can also be used for secure communication with anonymous sources. MANA assists with encrypting and decrypting email that may contain news tips or whistle blower information. A source can be registered like a new MLM member but as a source only. In source mode, MANA only submits NEDS that generate alerts to the sponsor so it must be edited before posting as a new version NEDS with source information removed. The NEDS sent by a source may be encrypted by MANA on the source's Network Device. A registered source has a public key on the PKS just like a member so the NEDS can be decrypted and the source verified.

Technology to Enable Real-Time News

MANA creates a news submission with NEDS and sends to NDS. MLM Members using MANA are authorized to report news. MANA assists the news report via sending of an email implementing NEDS. NDS the alerts MLM sponsor to a NEDS posting by MLM member. The MLM sponsor uses MANA to view and possibly edit the NEDS. The Sponsor then uses MANA to retrieve and sign the NEDS Signature File with the sponsor's private key to authorize distribution. Or, in the case of an edit, a new version the NEDS is submitted and the updated NEDS Signature File is signed. Of course, the MLM sponsor may contact MLM member as needed for clarification or coaching. The automated alert, editing, and signing with MANA allow for a distributed real-time managing editor authorization capability within the MLM.

MANA use Location Service in the Network Device to update NDS with current location. These updates allow the NDS to associated the Network Device's current location relative to recent new. The Location Updates also allow a historical location to be archived for each Network Device.

MANA updates NDS with location qualified category interest. MANA's category settings screen allows the selection of categories of interest and a maximum distance from current or historical location where the interest is valid. In addition, specific locations can selected for monitoring. For example, one may select their mother's house as a specific location so she may be warned of current news by a phone call. These settings are stored to the NDS via Alert Preferences in Other Data.

NDS uses NEDS location data and Alert Preferences to generate alerts with LANA. When new NEDS data is posted, NDS notes the NEDS location and categories and matches them with Location Data and Alert Preferences for active Network Device running MANA. Likewise, when a Network Device running MANA come on line, NDS scans through recent NEDS data for matches with Location Data and Alert Preferences. NDS generates alerts with LANA about news items that coincide with the reader's Alert Preferences and location data. The alert contains a link which is displayed on MANA to the news of interest on the News Web Site. For example, a reader might be alerted to a story about a hazardous materials situation near their house. Or, an alert may display a story about a wreck on a road historically traveled.

NDS uses location proximity to advertiser to generate alert with LANA. When a Network Device running MANA comes within proximity to an advertiser with the news service, an alert may be generated for advertising purposes. In addition, the categories in the Alert Preferences may be used to further prioritize alerts of an advertising nature.

NDS uses NEDS and category interest to alert advertiser with LANA. Advertisers can run MANA in a customer alert mode so that the advertiser is alerted when a potential customer comes within proximity of a storefront.

NDS uses high reader interest, category, and location proximity of advertiser to alert advertiser with LANA. NDS may detect high reader interest by a percentage increase in the moving average of stories clicked within a category within geographic proximity to a location. When a news story is selected in MANA, a News Link Clicked item is logged through Other Data. The logging can be used to determine stories and categories with high interest within geographical proximity to alert advertiser. For example, over the last few weeks, an average of twenty people a day read stories about crime within a mile of a hardware store which is a news service advertiser, so the weekly moving average is twenty readers in the crime category. The following week, thirty people a day select stories about crime in the area indicating a 50% increase above the weekly moving average, NDS detects this pattern and alerts the advertiser to an automated report about high interest in crime in the area. The advertiser is likely to purchase additional advertising promoting his security products like locks or security lights.

NDS uses location proximity, location history, category history, and high reader interest to alert reporters with LANA. NDS may detect high reader interest by a percentage increase in the moving average of stories clicked within a category within geographic proximity to a reporters average location. NDS detects this pattern and alerts the reporter to an automated report on the readership interest change. The reporter may then contact knowns experts in the area to better report on the category of interest.

MANA uses NEDS as a location and or category news request. A person running MANA on a Network device may request news. MANA may be used to send picture of a item or location of interest as NEDS data with a request designation in the category. NDS extracts the location from the NEDS request. and generates an alert with LANA with a news request category. MLM members who are linked to the proximity of the picture receive the news request alert and know that there is interest at the location of the picture related to the subject portrayed in the picture. For Example, a frequently traveled road is closed for construction. A reader uses MANA to take a picture of the road closed sign and sends the picture as news request. Publishers linked near this location receive the picture know that there is interest in the road closure and may write an article about why it is closed and when it will reopen. The articles generate local news events back to the reader since they would have a historical location coinciding with the closed roads location.

### CONCLUSION, RAMIFICATIONS, AND SCOPE

Accordingly the reader will see that, according to at least one embodiment, this news service will provide the best opportunity for every community to have a news website focused on their local news, created by their citizens and funded by advertising from their local businesses. The embodiments discussed above overcome all the current disadvantages of traditional and citizen reported news services. These disadvantages of traditional and current citizen reported news services include: limited financial and human resources, no news coverage in small communities, bias in reporting, limited advertising space, limited appeal to advertisers in communities without news coverage, online news that is redundant to the traditional source, citizen reporting with no financial benefit to the citizen, citizen reporting that is mostly personal opinions and not news, and no independent source for original local news content.

These novel systems in this patent application provide many advantages not available by current news services. These advantages include: Any citizen can start a business as a local independent publisher, any community can have their own news service, any business can advertise to local citizens through a local news service, there are no limitations on the amount and scope of news that can be created, there are no limits on the dissemination of news to citizens, the news services are self funded by LIPs receiving financial benefits for reporting news from the advertising revenue of local businesses, and the news services are self regulated by news articles and reporters being given ratings by other local citizens on various accuracy and relevance metrics.

The members of the MLM, subscribed readers, and advertisers use MANA to communicate with News Distribution Service (NDS). The application can be used to report news using NEDS as well as provide continuous device location data. The NDS provides Location Applicable News Alert (LANA) to devices running MANA. The alerts can provide real-time news specific to location such as a police situation down the street or an accident on a road historically traveled. In addition, a reporting member's sponsor can be alerted to the posting so they may exercise their role as a “managing editor” to improve reporting or mitigate any issues such as legal or ethical transgressions. The invention's technology enables real-time news and distributed “managing editors” without any centralized direction or overhead costs of a traditional, centrally managed, organization thus solving the business challenge to coordinate faster news distribution.

We believe this invention is patentable because there is no prior art of this idea and for the following secondary reasons:

The Potential Commercial Success of the Invention

The invention would create a community news service for any community in the United States. And the invention would create an opportunity for local businesses in small communities to advertise directly to citizens of their community. Neither of these exists in large scale today. As discussed in this application, there is very large commercial potential in the local advertising market that is not being tapped by the marketplace today.

The Invention Will Satisfy Long Felt Needs in the Industry

There are two long felt needs that are not being satisfied in today's marketplace. One is the need of citizens in small and medium size communities to have access to local, independent news about their communities. And the second is the need of small businesses in small and medium sized communities to have access to a medium to targeted advertising to current and potential customers in their local communities. As discussed in this application, news organizations are trying many different models to try to expand their reach to local communities and provide local news. And many internet companies such as Google. Yahoo, Facebook and Twitter are trying many models to try to tap into the very large commercial potential of local advertising.

Failure of Others to Find a Solution to the Problem at Hand

Today there is little to no news content available in the majority of small and medium size communities. News organizations have tried hiring journalists in local areas or paying them per story. Patch.com is an example of this and it is failing along with many others. Other news organizations have tried to entice citizens of small and medium size communities to write articles for free and do it as a community service. NewsVine.com is an example of this that is also failing along with many others. Nobody has been able to figure out a compensation model that works in small and medium size communities.

Other companies are trying to focus on the local advertising market. Yahoo, Google, Facebook and Twitter want local businesses to advertise on their sites. But they have failed to make any significant traction with small businesses. It is too hard for the small businesses to target their communities and specific current and prospective customers. There is not enough local content or the local content is confined to social groupings that limit the ability to advertise to the general public in the local communities.

Unexpected Results

Nobody has devised a system to combine multi-level network marketing with the news industry. However, the unexpected result is that it solves the 2 biggest needs in the news industry for local communities. Number one it compensates the citizens for reporting news in their local community, thereby providing incentive to do so. Number two it provides the local businesses a medium to market directly to citizens of their community who will be reading the community specific news, thereby giving them an opportunity to target their advertising in their community.

Why is this Invention Beneficial to the Marketplace?

Increased Employment—

This invention will enable millions of Americans to earn income from selling advertising, writing articles of local interest, and recruiting others to do the same. This employment will be evenly disbursed. Citizens in small and/or rural communities, where jobs are hard to get, will have just as much opportunity to benefit from this invention as those in larger communities.

Greater Access to Community News—

Today it is easier to get news on international affairs than it is to get news on what is happening in your own community. Access to community news will be transformed. Any Citizen will be able to get online and read a free news service, open to any person, with unlimited news and unlimited categories that are specific to their community. This does not exist today.

New, Targeted Advertising Opportunities for Local Businesses—

Current advertising opportunities for small, local businesses are limited and expensive. Most communities do not have their own newspaper, radio or TV station, or their own online news service. Advertising opportunities to target a very specific community or very specific category within that community are rarely available in today's marketplace.

This patent application can have a significant impact on all communities and will transform the use of “word of mouth” news that occurs today in most communities to an online resource for all areas of interest to each community's residents.

Improving the level of local news and using independent content has been an objective of many organizations for several years. These organizations are highly skilled in the matter. However, they have been unable to develop a system to motivate individuals in a community to actively participate and provide independent content to their organizations.

Multi-level marketing companies have existed for over 50 years. Just about every product and service has been offered through a multi-level marketing organization. However, all of these organizations are 2 dimensional in their structure. The first dimension is the selling of a product or service to customers. The second dimension that provides the accelerated growth potential in multi-level marketing is to recruit others to do the same, thereby creating multiple (multi-) levels of sales people that can earn compensation from their downline. These organizations are highly skilled in the matter. However, they have never considered “news” to be a product or service that fits with multi-level marketing because it is constantly changing and not well suited for the resale environment of the multi-level marketing structure. They have not attempted to utilize a third dimension to be able to create geographic compensation pools or article credit compensation pools, whereby news content is constantly created and members are compensated for it.

No prior art has found a solution for the void of availability and access to community news that is economically feasible and applicable to all communities. This invention has 3 key differentiating elements that enable it to fill that void.
Multi-level marketing networks are utilized to compensate an unlimited number of publishers in the community news service.
Geographic revenue pools are utilized that compensate these publishers from the revenue produced in their specific location. Advertising and business service revenues are segmented by location and these revenues are used to pay commissions and bonuses to publishers in that same location. This enables each community to have their own self-funded community news service.
Article credit pools are utilized to incentivize publishers to provide content to the news service. A portion of the revenue dollars in each location will be segmented to pay publishers for the content they provide to the community news service. This pool of revenue will be pro-rated to each publisher based on the number of their and their group's articles, amount of unique viewers of their and their group's articles, and the ratings of their and their group's articles. The pro-rated portion will be determined within each geographic location. This enables each community to have content specific to their community.

While the above descriptions contain many specifics, these should not be construed as limitations on the scope of any embodiment, but as exemplifications of the presently preferred embodiments thereof. Many other ramifications and variations are possible within the teachings of the various embodiments.

Thus the scope of the invention should be determined by the appended claims and their legal equivalents, and not by the examples given.

What is claimed is:

1. A system for providing community news services, utilizing network devices to establish news article locations and verify members, having a multi-level marketing network organization which comprises a system to compensate members of said multi-level marketing organization for work supporting said community news services comprising;
a) said members working as independent publishers, editors, reporters, and advertising marketers, independently deciding activity in each role, such as what news to publish.
b) said members working to recruit new members which become part of said member's down line multi-level marketing network group.
c) said members working to market advertising to businesses in a plurality of geographic locations.
d) said members working to create original news content for said news services by reporting news and events in a plurality of geographical locations in order to encompass locally pertinent news items in order to draw local internet traffic, which generates locally targeted advertising sales.
e) calculating utilizing a computer with a processor the commission and bonus for said members based on a compensation calculation comprising;
(i.) geographic locations of news items established by the members' network devices with geolocation capabilities.
(ii.) determining a geographic revenue pool for each geographic location based on advertising services revenue in said location.
(iii.) determining a news article credit pool for each geographic location based on published articles reporting news and events in said location.
(iv.) determining a member commission based on member's advertising service sales.
(v.) determining a member commission based on rated contribution to each said news article credit pool.
(vi.) determining a member bonus based on member contribution to each said geographic revenue pool and each said article credit pool.
(vii.) determining a member bonus based on the accumulated contribution of said member's down line multi-level marketing network group to each said geographic revenue pool and each said news article credit pool.
f) plurality of said members of said multi-level marketing network organization, consumers and advertisers connect utilizing personal computers or network devices with geolocation capability,
g) plurality of said members provide content for community news services by entering local news stories in electronic format including geolocation information and signed with said member's cryptographic identity using personal computers or network devices,
h) plurality of local businesses provide advertisements to said multi-level marketing network organization in electronic format using personal computers or network devices,
i) said content and advertisements are stored on database servers,
j) websites for said community news services, members and advertisers are constructed with application servers that pull said content and advertisements from said database servers,
k) said members, consumers, and advertisers utilizing an internet use personal computers or network devices to access said websites.

2. The system of claim 1, wherein a system for providing community news services is created for any locality comprising:
a) content originating from members of the multi-level marketing network organization,
b) plurality of members of multi-level marketing network organization report local news specific to their geographic location,
c) said members recruit individuals to be members of said organization and to report community news,
d) plurality of geographic locations that each have news services specific to each locality created by content from plurality of members in that locality.

3. The system of claim 1, wherein a system for new advertising opportunities are created for local businesses comprising:
a) plurality of members of a multi-level marketing network organization,
b) said members market advertising to local businesses within the member's geographic location,
c) said advertising is segmented into categories of interest for said news service,
d) said members recruit individuals to be members of said multi-level marketing network organization and to market advertising to local businesses,
e) plurality of local businesses advertise on said community news service,
f) said local businesses can target their advertising to said geographic locations,
g) said local businesses can target their advertising based on said categories of interest within said geographic locations.

4. The system of claim 1, wherein a system for a self-regulated news service is created by further comprising:
a) a rating system for consumers to rate the news articles,
b) said consumers can rate news articles on the news services based on predetermined criteria,
c) said ratings are used to remove fraudulent or malicious news articles from the news service,
d) said ratings are used to restrict members, who have written fraudulent or malicious news articles, from reporting more news articles,
e) said ratings are used in calculating the compensation of members of the multi-level marketing network organization.

5. The system of claim 1, wherein a portal internet website for community news services is created by further comprising:
a) plurality of said community news services,
b) said community news services are segmented by geography,
c) a single portal internet website provides a starting point to access any of said community news services,
d) said portal internet website provides a web search function,
e) said search function is able to search on a plurality of criteria.

6. What is claimed is a system for providing real-time local news services specific to any geographic location comprising:
a. A multi-dimensional marketing network comprising:
i. Plurality of members of a multi-level marketing network
ii. Plurality of member groups formed by said members in a multi-level marketing network
iii. A geographic dimension of said multi-level marketing network consisting of geographic subgroups based on the geographic location of said members and member groups to keep revenues in that geographic location to fund the news service of each geographic location comprising:
1. Advertising and business services revenue generated by said members and member groups within a geographic location
2. Geographic revenue pools for each geographic location to compensate said members of the multi-dimensional marketing network from revenue generated in selling advertising and business services in each geographic location by said members and member groups
iv. A content-creation dimension of said multi-level marketing network consisting of article credits issued to said members and member groups for creating content in each geographic location to incent news creation for each geographic location comprising:
1. Articles created on a network device with geolocation capabilities to establish a position in a geographic location.
2. Article credits given to said members and member groups for creating original news articles
3. Plurality of articles created by said members and member groups segmented by geographic location and by specific timeframes.
4. Plurality of unique viewers of said articles by the public segmented by geographic location and by specific timeframes
5. Article credit revenue pools for each geographic location to compensate said members of the multi-dimensional marketing network from revenue generated in each geographic location for creating news content for each geographic location
b. A computer with a processor that performs real-time calculations for said news service and said multi-dimensional marketing network comprising:
i. Calculations totaling in real-time the advertising and business service revenue for each said member and member group segmented by geographic location and by specific timeframe.
ii. Calculations totaling in real-time the number of articles written and unique visitors for each article for each said member and member group segmented by geographic location and by specific timeframe.
iii. Calculations in real-time of the geographic revenue pool for each geographic location, for each said member, and for each said member group
iv. Calculations in real-time of the article credits attributable to each said member and member group, segmented by geographic location.
v. Calculations in real-time of the article credit revenue pool for each geographic location, for each said member and for each said member group
c. A distributive computer network comprising:
i. Plurality of network devices using network connected applications comprising:
1. authentication services
2. location services
3. media services
ii. Plurality of database servers to store and distribute information in real-time
1. gather and store in real-time news articles created by members of said multi-dimensional network marketing organization
2. to gather and store in real-time advertisements sold by said members for the news service.
3. gather and store in real-time business metrics of said multi-dimensional marketing organization consisting of:
a. number of articles written per member per group per geographic location
b. number of page views per article per member per group per geographic location
c. number of advertisements sold per member per group per geographic location
d. number of views and click-throughs per advertisement per member per group per geographic location
iii. Plurality of application servers to construct webpages in real-time by accessing said database servers comprising:
1. web page constructed from said application servers to provide said public news service of local news articles, published in real time, for each geographic location
2. web pages constructed from said application servers for said advertisers to track business metrics of their advertising in real time
3. web pages constructed from said application servers for said members to track business metrics of their business metrics in real time
iv. Plurality of web browsers used to access said web pages to view real time data using a content access device connected to an online communication network like the internet comprising:
1. a public website that can be accessed by said web browsers and is available to the general public and provides local news for each geographic location in real time
2. an advertiser website that can be accessed by said web browsers and is available only to said advertisers, for use in conducting their advertising business in real time
3. a member website that can be accessed by said web browsers and is available only to said members, for use in conducting their multi-level marketing business in real time
